(19) United States
(12) Patent Application Publication
(10) Pub. No.: US 2015/0172743 A1
(43) Pub. Date: Jun. 18, 2015

(54) REMOTE OPERATION SYSTEM AND TERMINAL DEVICE

(71) Applicant: Hitachi Maxell, Ltd., Ibaraki-shi, Osaka (JP)

(72) Inventor: Tsuguo Itagaki, Ibaraki (JP)

(21) Appl. No.: 14/402,125

(22) PCT Filed: Mar. 13, 2013
(86) PCT No.: PCT/JP2013/056888

§ 371 Date: Nov. 19, 2014

(30) Foreign Application Priority Data
Aug. 24, 2012 (JP) 2012-184766

(51) Int. Cl. H04N 21/422; H04M 1/725; H04N 5/00; H04N 21/436; H04N 21/482; G08C 17/00; H04M 11/00

(52) U.S. Cl. CPC H04N 21/42207; G08C 17/00; H04M 1/72533; H04M 11/00; H04N 21/42209; H04N 21/4222; H04N 21/436; H04N 21/4821; H04N 5/00

(57) ABSTRACT

The present invention can provide a remote operation system which can support compatibility between devices and is easier to use. A remote operation system is provided with a terminal device, a control device, and a controlled device. The terminal device is provided with a display unit for displaying operation screen information, an input unit for accepting the input of an operation on the controlled device, the input being performed on the basis of the operation screen information, and a first connection unit for receiving the operation screen information for displaying an operation screen on the display means from the control device and transmitting operation information to the control device on the basis of the operation accepted by the input means. The control device has a configuration provided with a control information conversion unit for converting the operation information received from the terminal device into control information for controlling the controlled device, and a second connection unit for transmitting the control information outputted from the control information conversion unit to the controlled device, and acquiring state information relating to the controlled device.

### TECHNICAL FIELD

The present invention relates to a remote operation system for remotely operating an audio-video device or the like from a distant location and a terminal device for use in the remote operation system.

### BACKGROUND ART

As background art in the present technical field, there is Japanese Patent Application Publication No. 2010-212774 (Patent Literature 1). In this publication, the following description is found: “provides a method and system for remotely operating electrical appliances, the method and system being capable of remotely operating a plurality of electrical appliances installed in an area such as a home with a single communication terminal device, which give better cost performance and are easily controllable, as well as a communication terminal device and a communication relay device for use in such system”.

### CITATION LIST

### Patent Literature

Patent Literature 1: Japanese Patent Application Publication No. 2010-212774

### SUMMARY OF INVENTION

### Technical Problem

Patent Literature 1 mentioned above discloses a method and system or the like that are capable of remotely operating a plurality of electrical appliances with a single communication terminal device. However, in the case of the invention described in Patent Literature 1, a communication relay device is needed to relay communication between a communication terminal device and an external communication network, a method or the like for supporting compatibility with a device of another company is not disclosed, and usability for users was not satisfactory.

The present invention has been developed in view of the foregoing and an object of the invention is to provide a remote operation system that can support compatibility between devices and is more convenient for use.

### Solution to Problem

In order to solve the above problem, it is expedient to adopt, for example, a configuration described in the claims. To take up an example, the present invention resides in a remote operation system including a terminal device, a control device, and a controlled device, in which the terminal device includes a display unit that displays operation screen information, an input unit that accepts an input for an operation to operate the controlled device, made based on the operation screen information, and a first connection interface unit that receives operation screen information for displaying an operation screen on the display means from the controlling device and transmits operation information based on the operation accepted by the input means. The controlling device is configured including a unit for conversion to control information for converting operation information received from the terminal device to control information for controlling the controlled device and a second connection interface unit that transmits control information which has been output from the unit for conversion to control information to the controlled device and obtains status information on the controlled device.

### Advantageous Effect of Invention

According to the present invention, a remote operation system that is more convenient for use can be provided.

### BRIEF DESCRIPTION OF DRAWINGS

FIG. 1A is a block diagram depicting an example of system architecture.

FIG. 1B is a block diagram depicting an example of structure of a television receiver.

FIG. 10 is a block diagram depicting an example of structure of a wireless terminal.

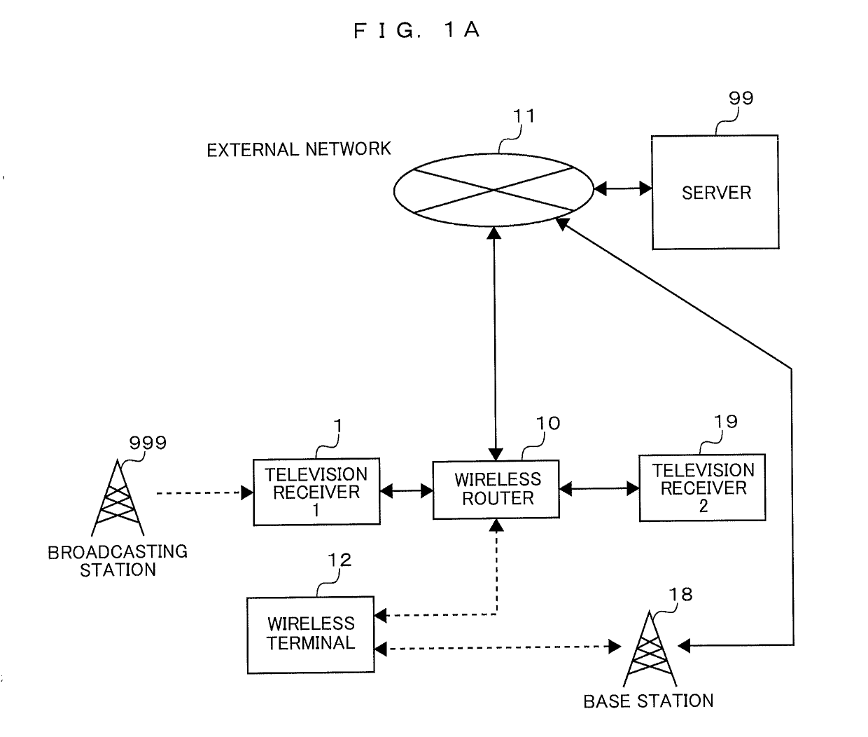

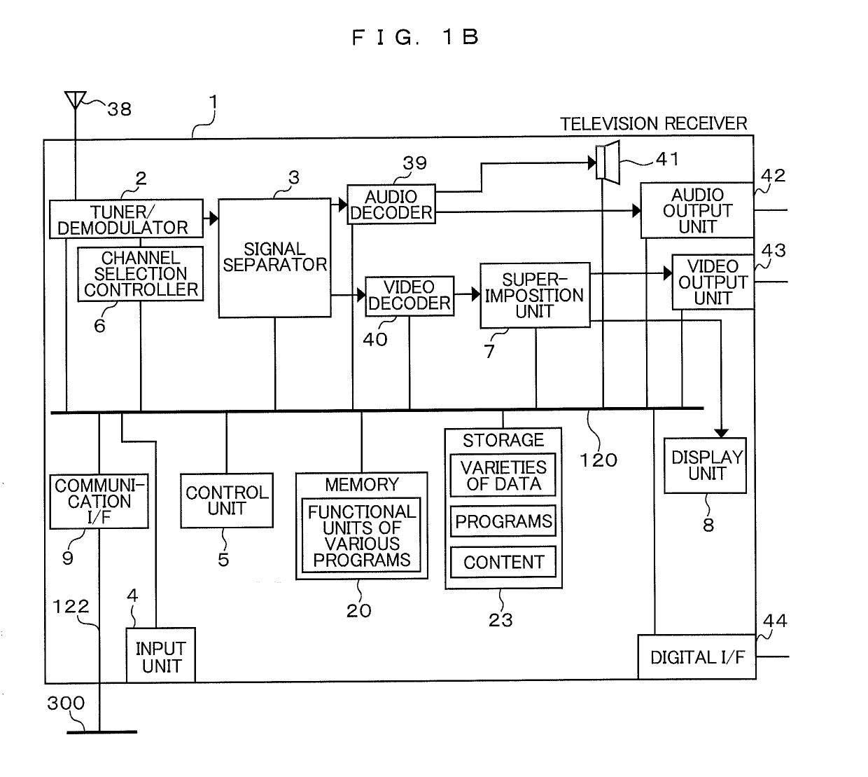

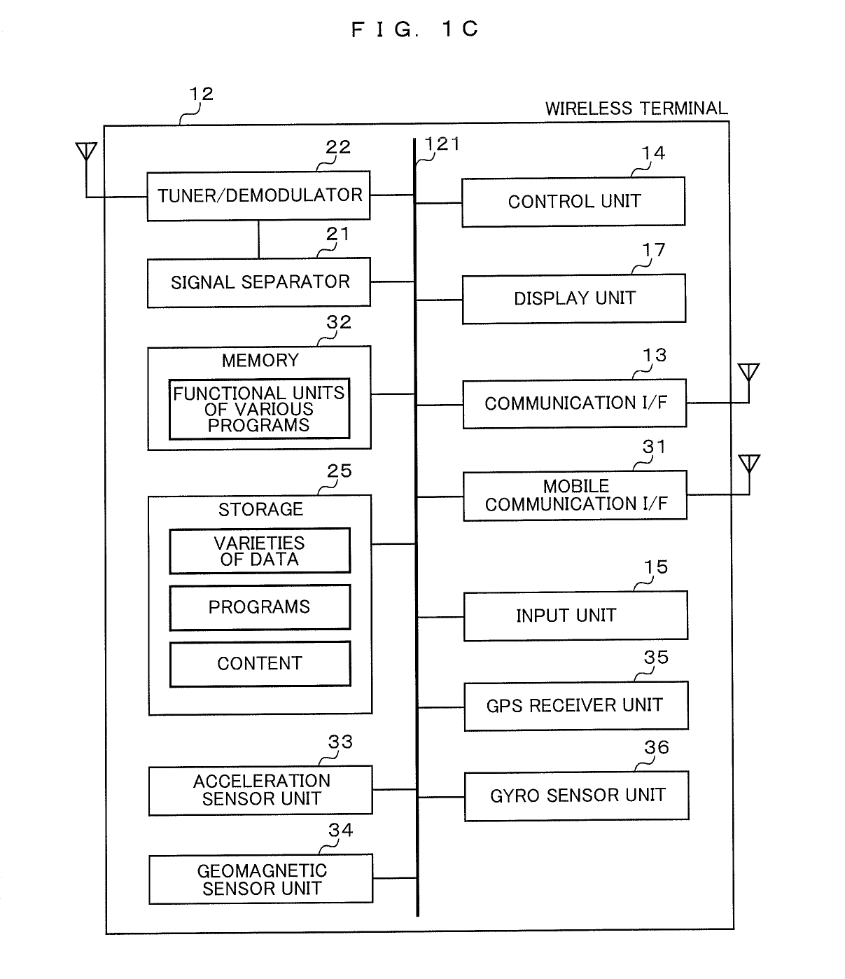

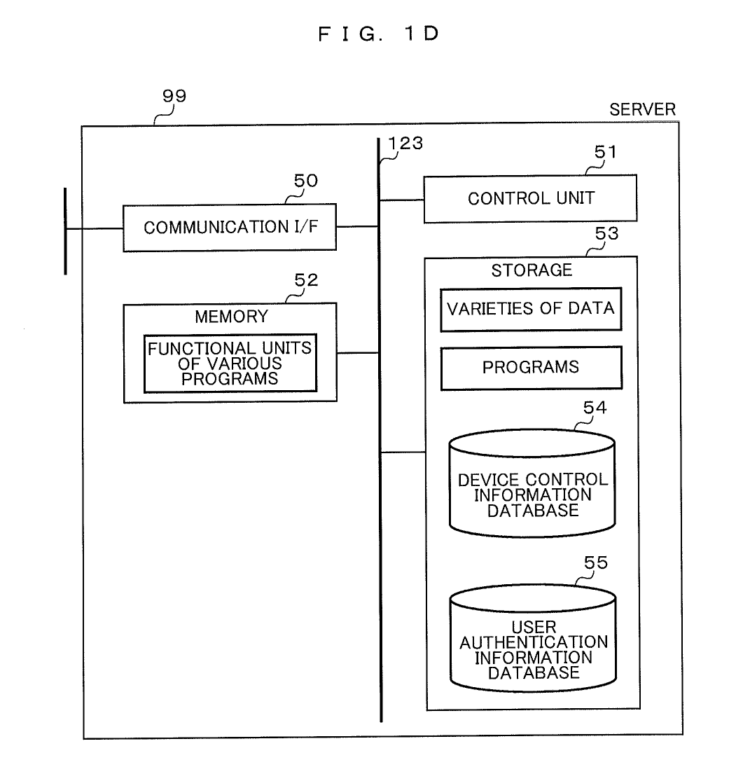

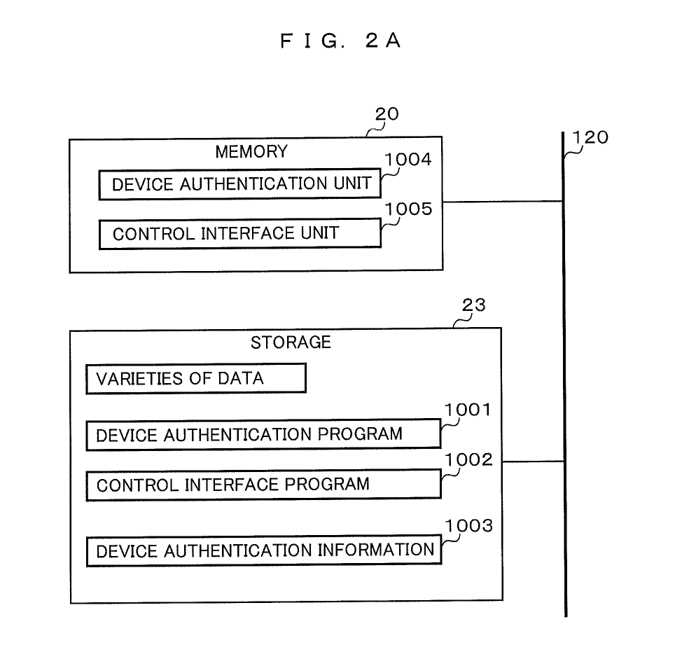

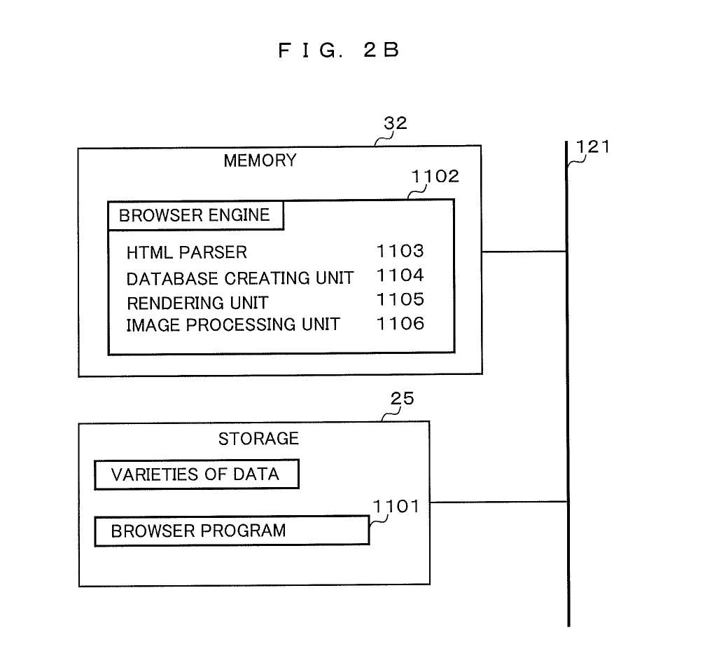

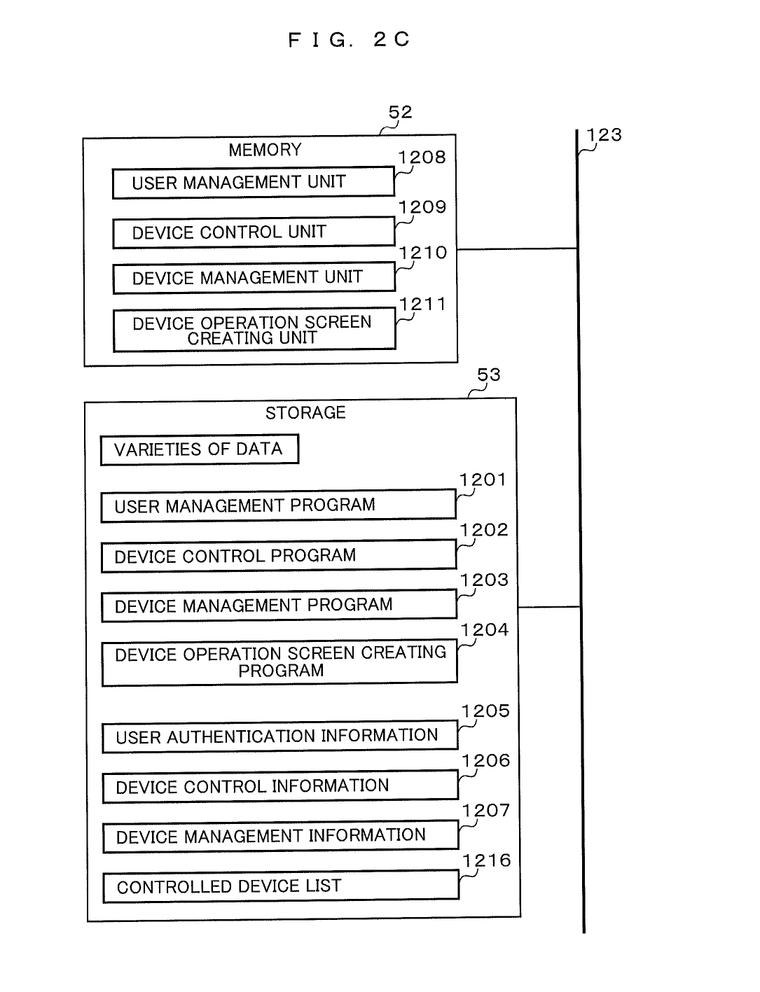

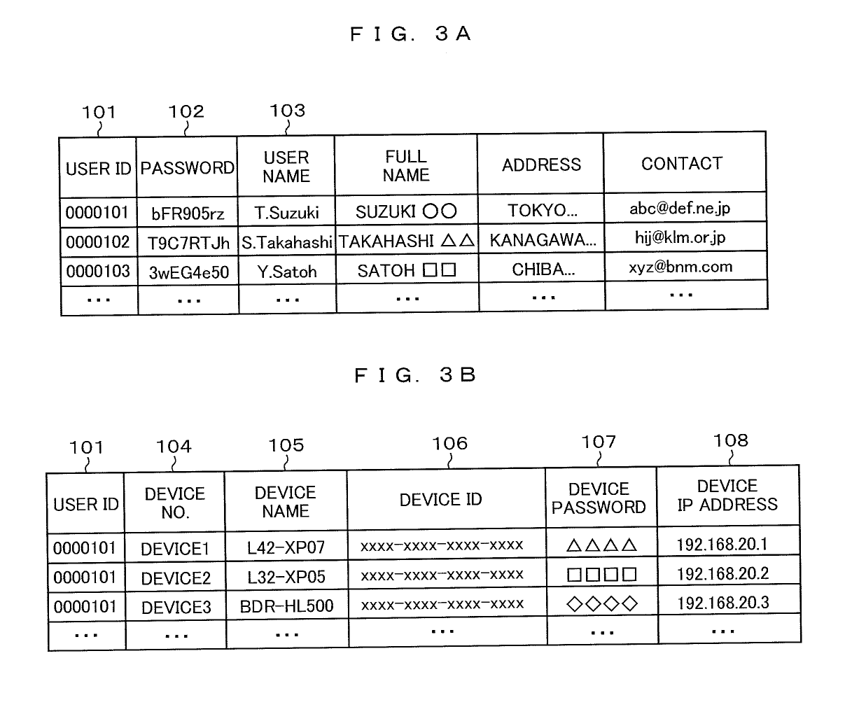

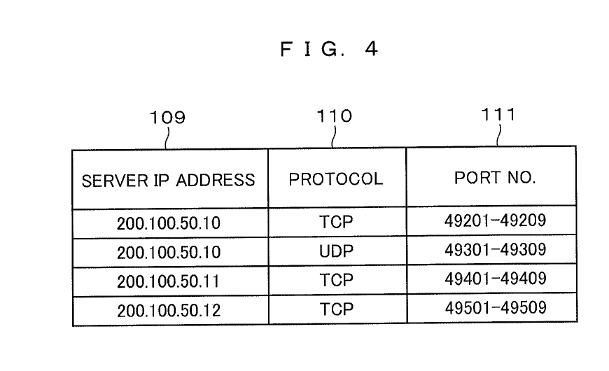

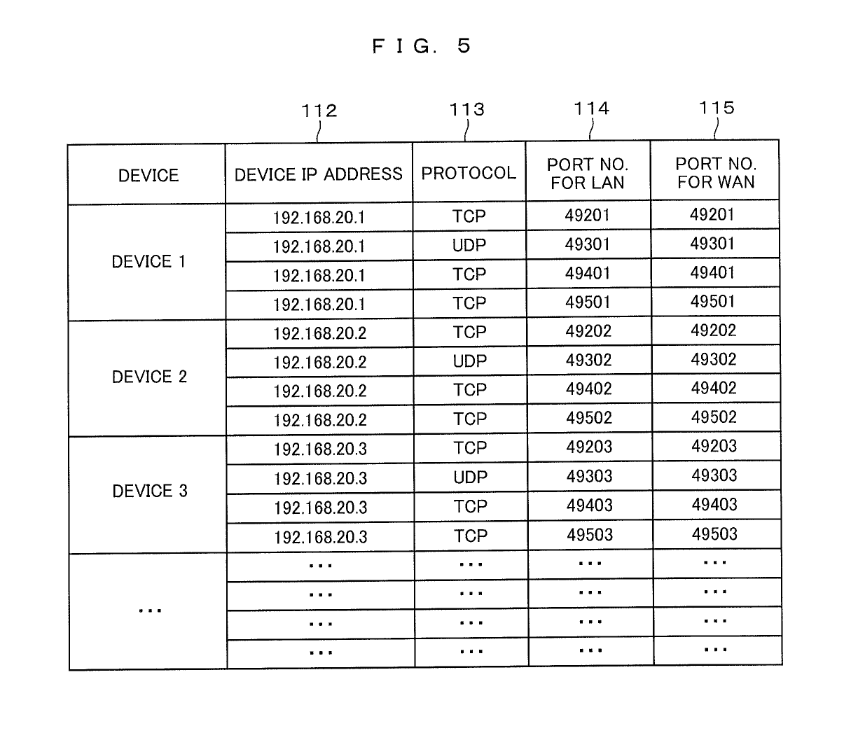

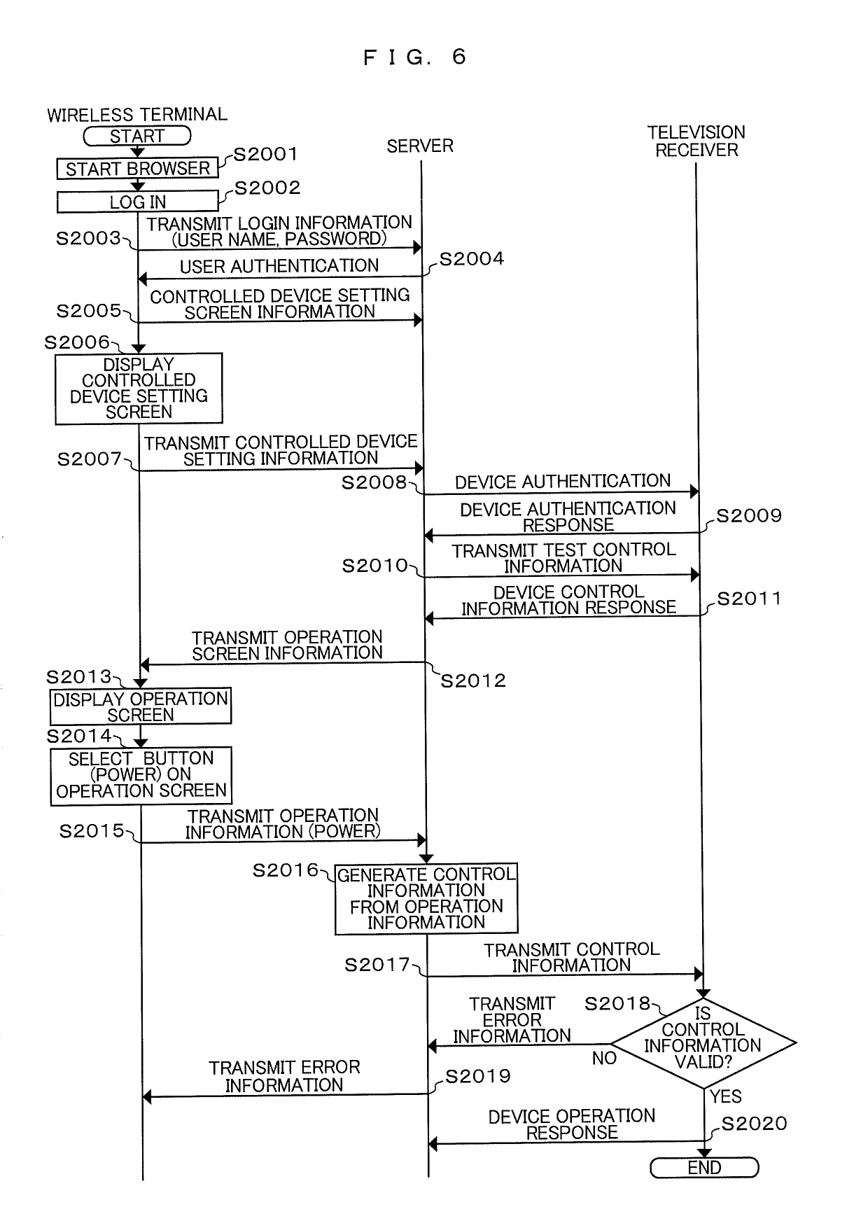

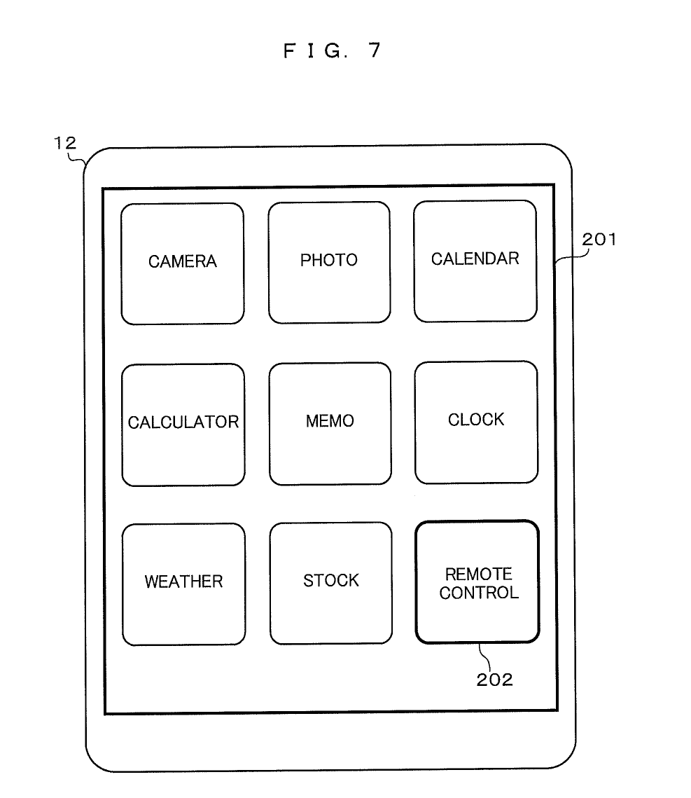

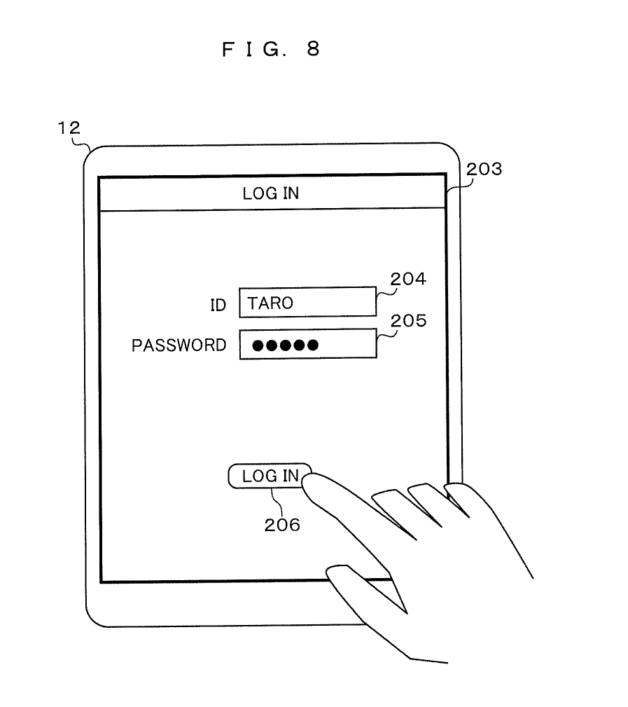

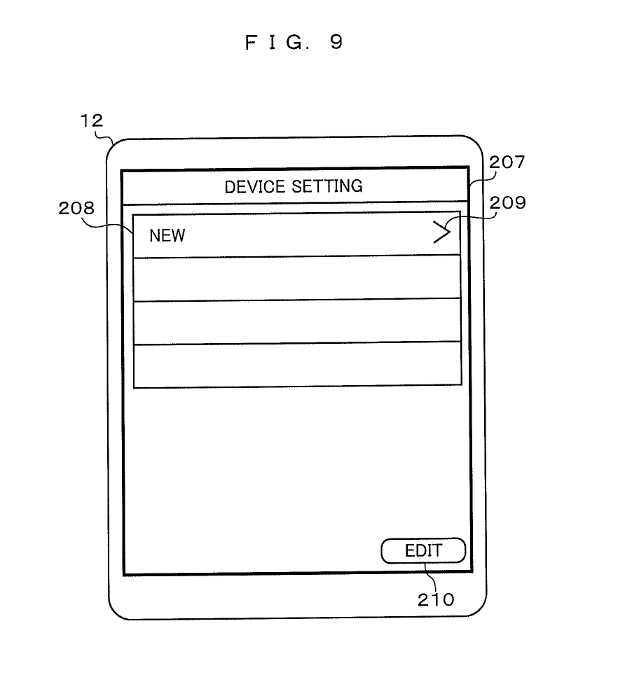

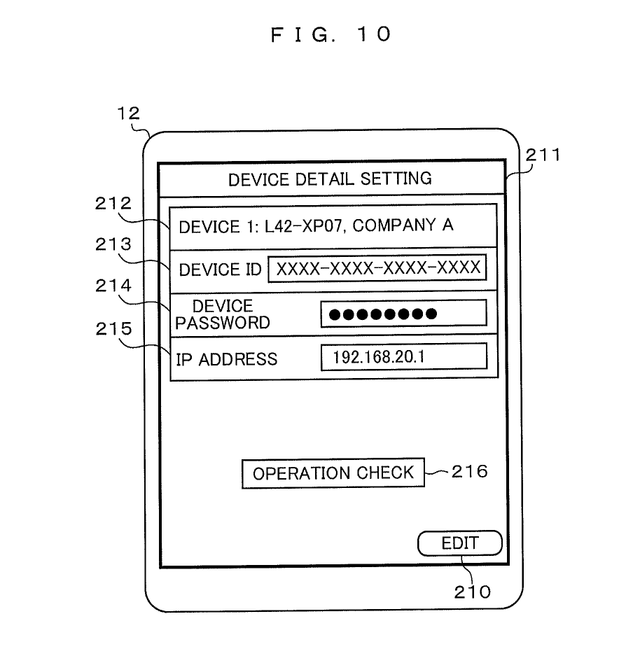

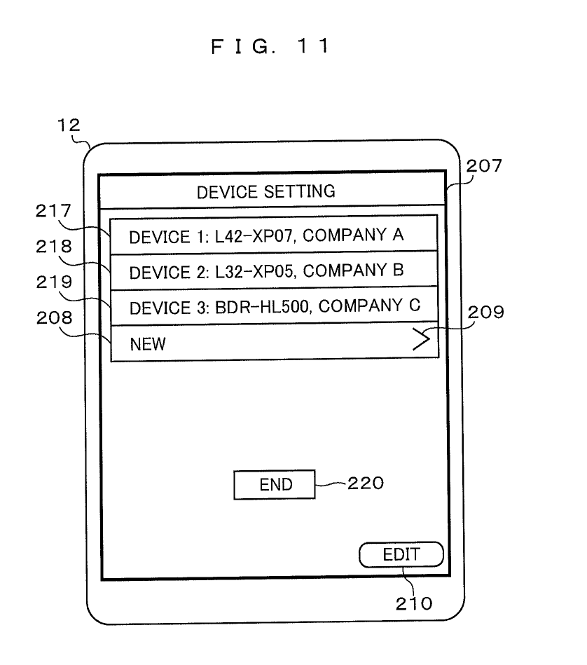

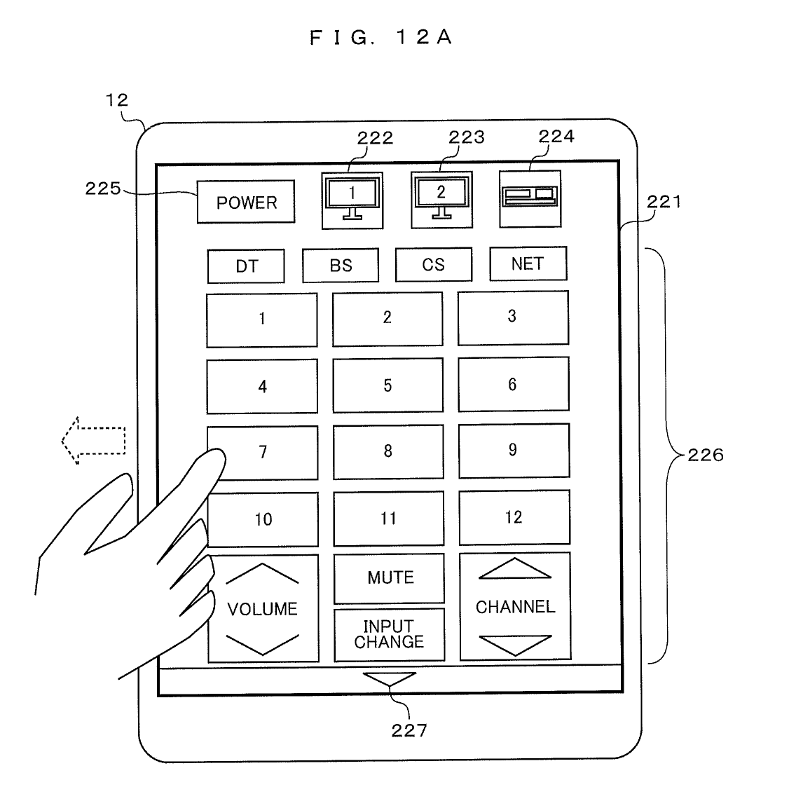

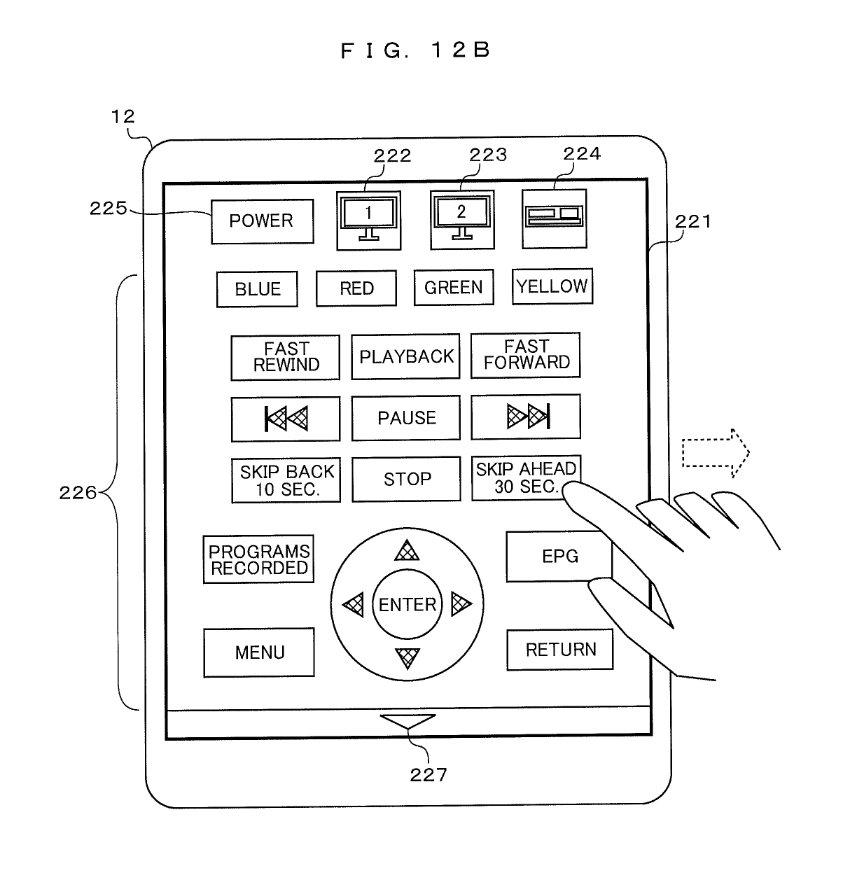

FIG. 1D is a block diagram depicting an example of structure of a server.

FIG. 2A is an example of internal structure of the storage and memory of the television receiver.

FIG. 2B is an example of internal structure of the storage and memory of the wireless terminal.

FIG. 2C is an example of internal structure of the storage and memory of the server.

FIG. 3A is a data table representing an example of contents of user authentication information that is managed by a user management unit on the server.

FIG. 3B is a data table representing an example of contents of device management information that is managed by a device management unit on the server.

FIG. 4 represents a setting example of an access list that is set in advance on a wireless router for permitting access from a server.

FIG. 5 represents a setting example of NAPT that is set on the wireless router.

FIG. 6 is a diagram illustrating an example of an operation sequence pertaining to a first embodiment.

FIG. 7 depicts a display example of a menu screen on the wireless terminal.

FIG. 8 depicts a display example of a login screen on the wireless terminal.

FIG. 9 depicts a display example of a controlled device setting screen on the wireless terminal.

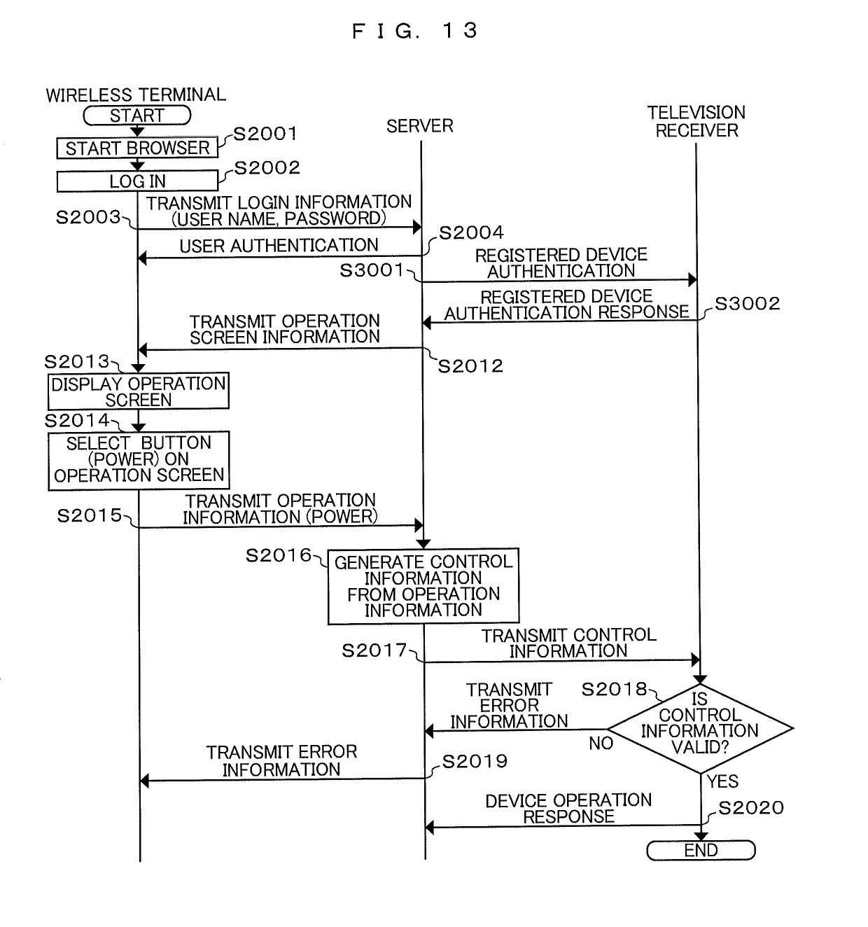

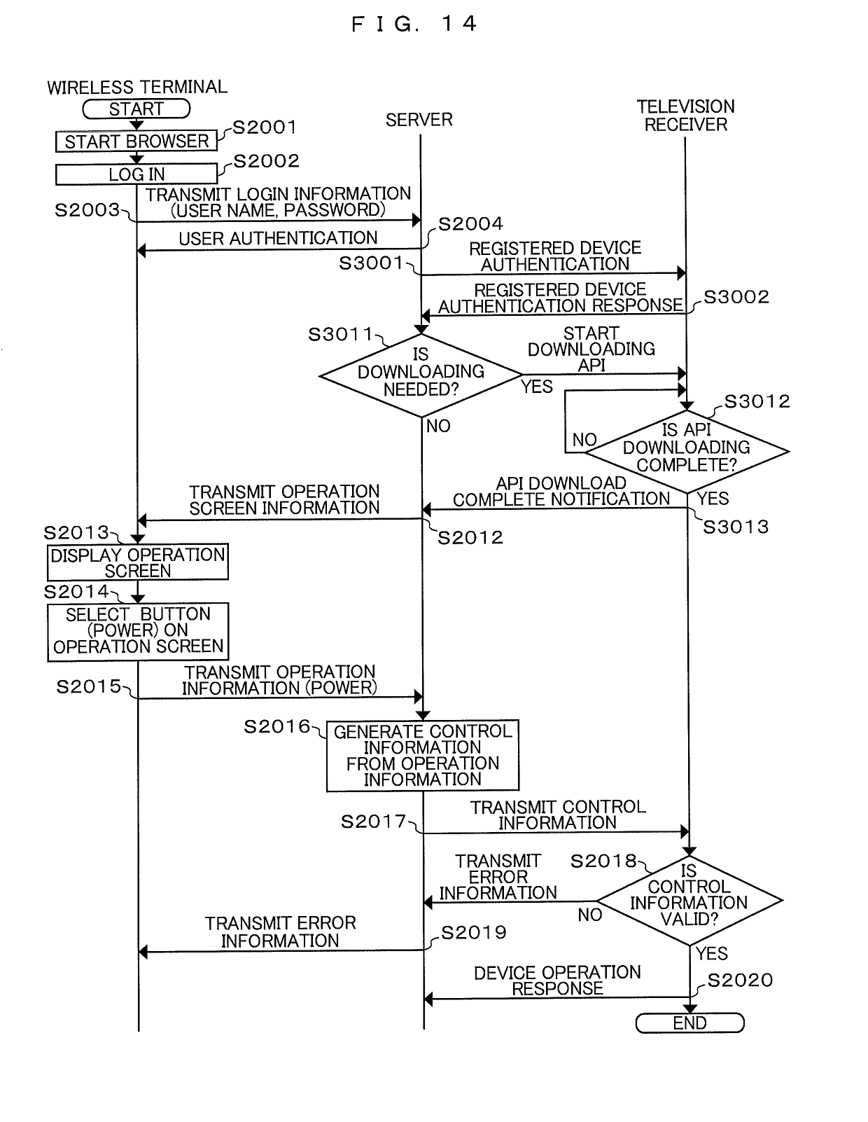

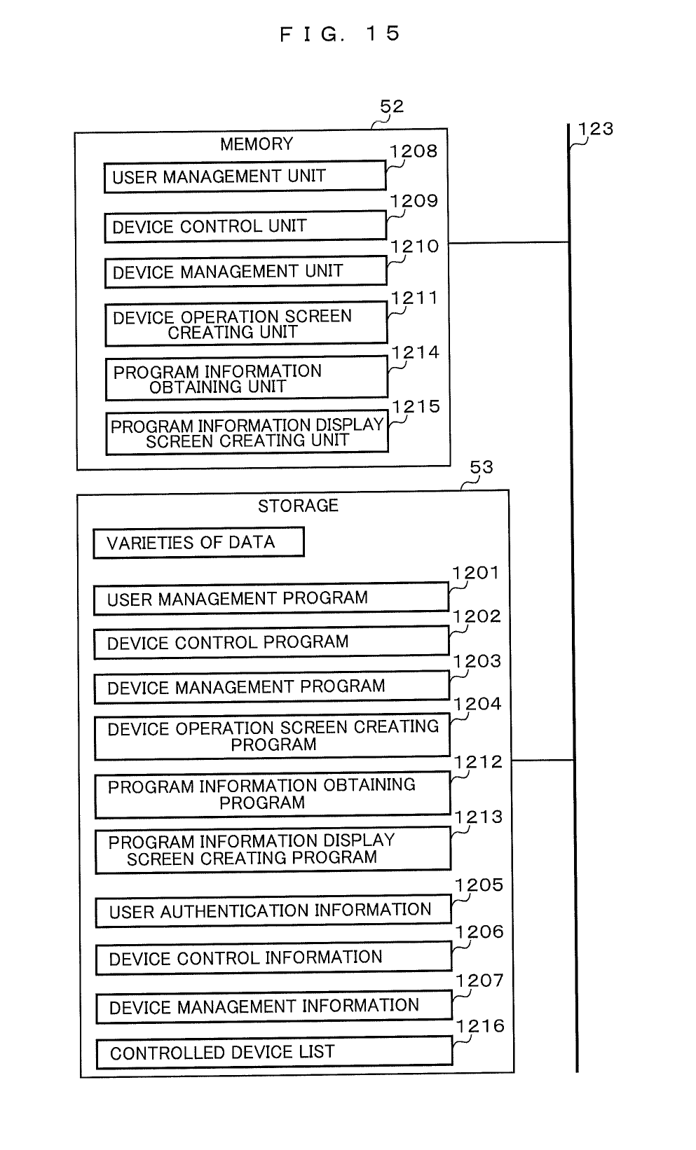

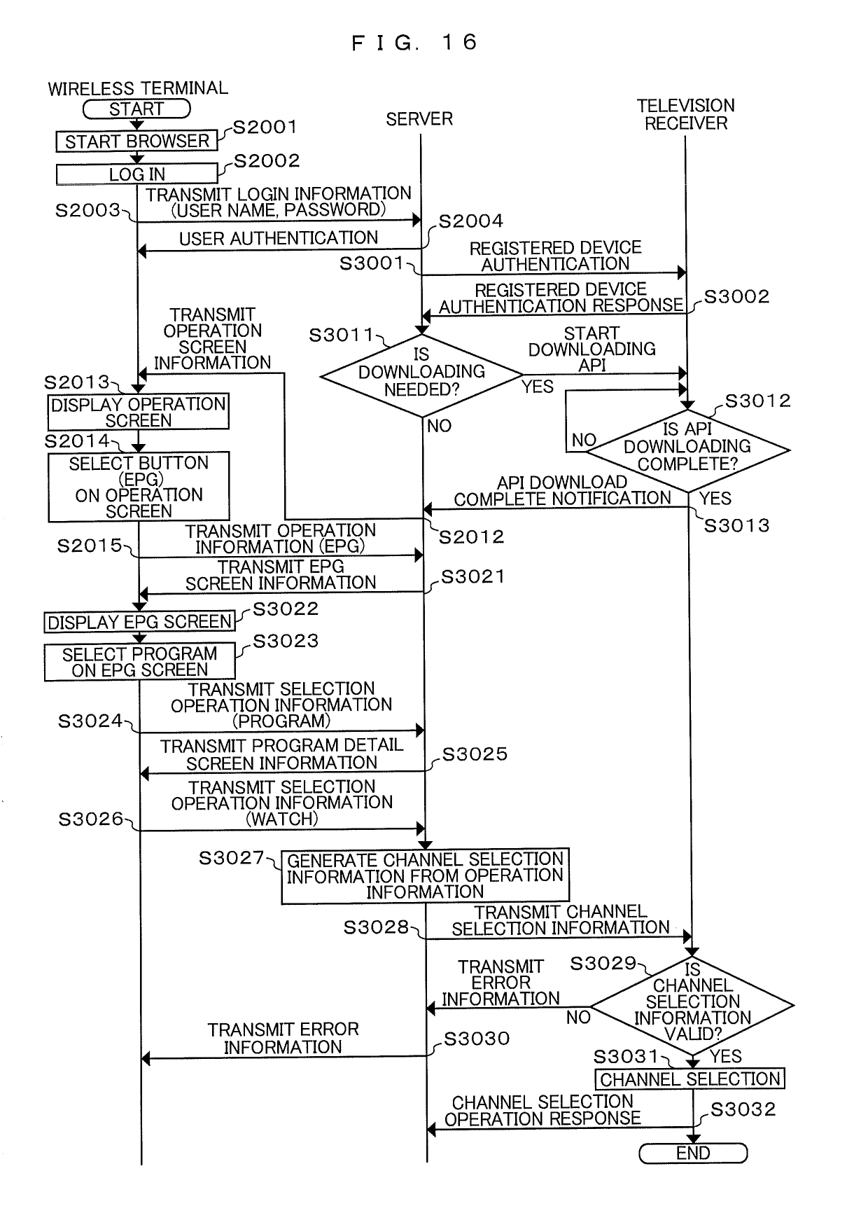

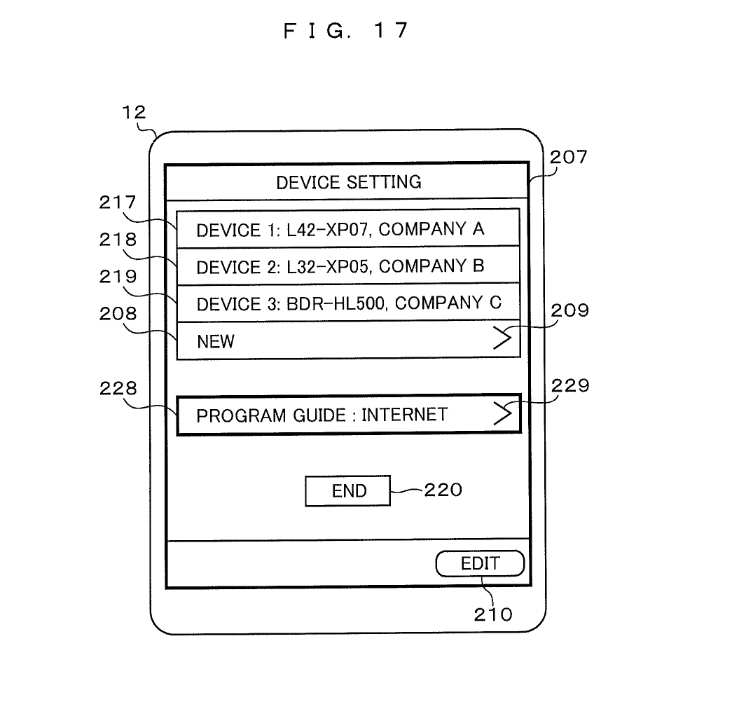

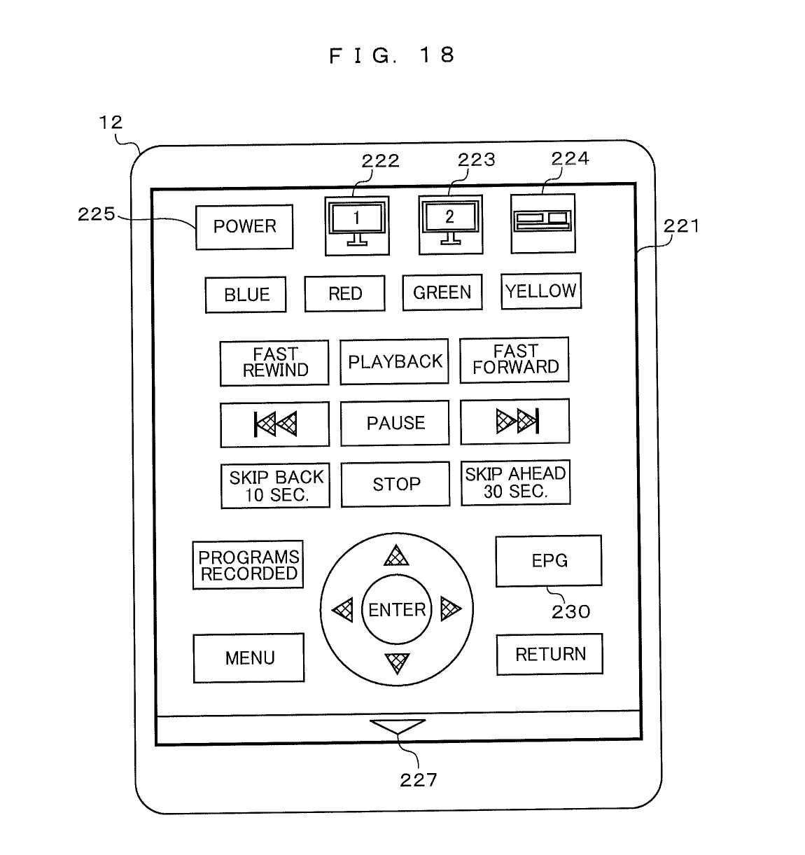

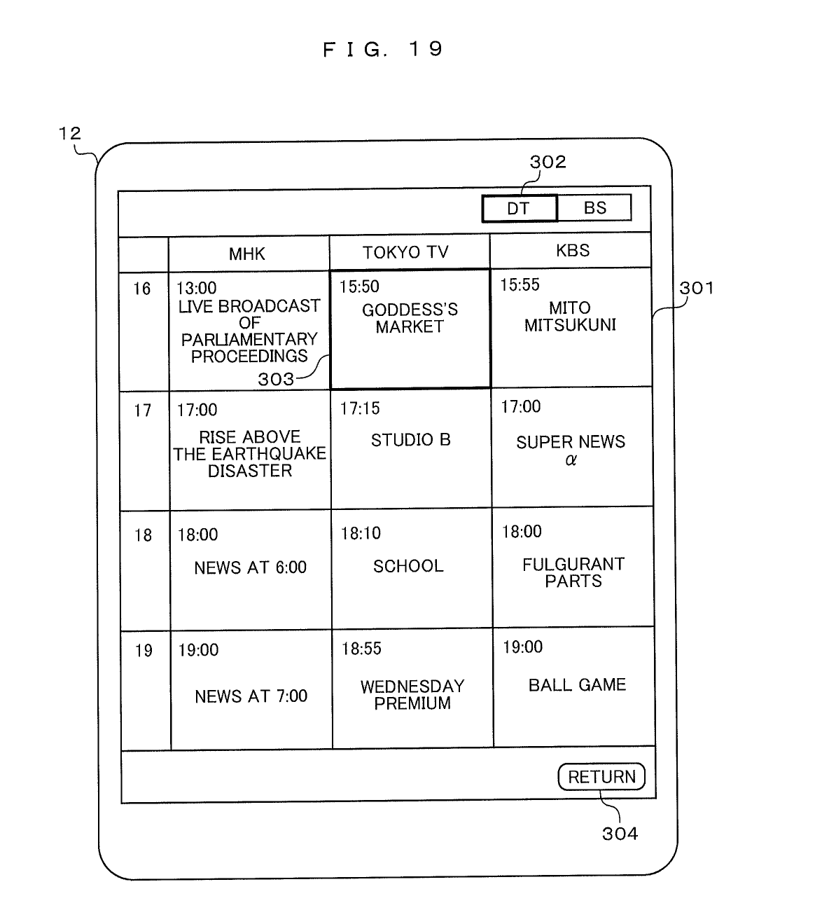

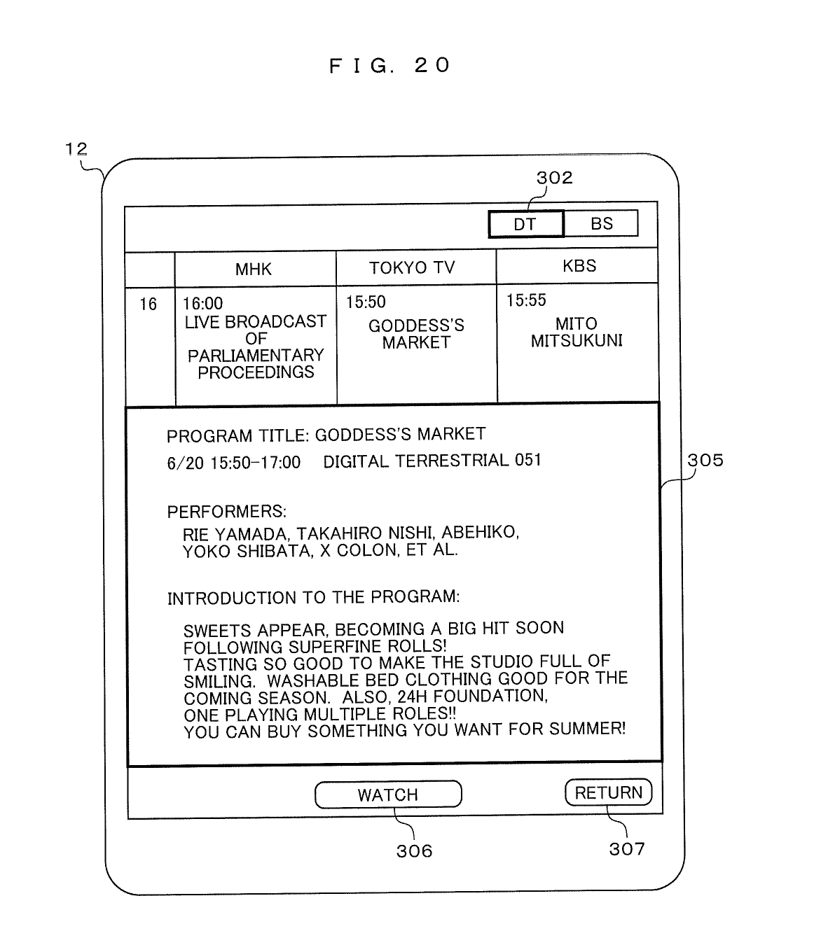

FIG. 10 depicts a display example of a device detail setting screen on the wireless terminal.

FIG. 11 depicts a display example of a device setting screen in which devices 1 to 3 have been set on the wireless terminal.

FIG. 12A depicts a display example of an operation screen on the wireless terminal.

FIG. 12B depicts a display example of an operation screen on the wireless terminal.

FIG. 13 is a diagram illustrating an example of an operation sequence pertaining to a second embodiment.

FIG. 14 is a diagram illustrating an example of an operation sequence pertaining to a third embodiment.

FIG. 15 depicts the storage and memory drawn from the structure of the server 99 in FIG. 1D.

FIG. 16 is a diagram illustrating an example of an operation sequence pertaining to a fourth embodiment.

FIG. 17 depicts a modification example of a device setting screen on the wireless terminal.

FIG. 18 depicts a display example of an operation screen on the wireless terminal.

FIG. 19 depicts a display example of an EPG screen on the wireless terminal.

FIG. 20 depicts a display example of a program detail screen on the wireless terminal.

### DESCRIPTION OF EMBODIMENTS

In the following, embodiments of the present invention will be described with reference to the drawings.

### First Embodiment

In the following, descriptions are provided, taking up as an example a communication terminal system including television receivers with a digital broadcast receiving function, which receives digital broadcast waves including service information (event information) and displays an Electronic Program Guide (EPG) of digital broadcasts based on the received service information, and wireless devices.

In BS digital broadcasting, CS digital broadcasting, and Digital Terrestrial (DT) TV broadcasting which are put in operation in Japan, a plurality of transport streams (hereinafter, transport stream will be abbreviated to “TS”) are multiplied in a single transponder (frequency channel) and transmitted. A TS has a data structure complying with a standard established by Association of Radio Industries and Businesses (ARIB) and is comprised of TS packets in which service information as event information is attached to an elemental signal (ES: Elementary Stream) as content data as a header.

A data structure of service information complies with an ARIB standard, ARIB STD-B10 “Service Information for Digital Broadcasting System”. Service information is comprised of PSI (Program Specific Information) which is transmission control information prescribed by an MPEG (Moving Picture Expert Group)-2 system standard and SI (Service Information) for constructing an EPG or the like.

SI is comprised of four tables: BIT (Broadcaster Information Table), SDT (Service Description Table), EIT (Event Information Table), and TOT (Time Offset Table).

A BIT describes information relevant to broadcasters within a network. An SDT is divided into a TS information part and a service information part and the TS information part includes a network ID for identifying a network and a TS ID (Identifier) for identifying a TS.

As regards network ID, different network IDs are assigned to a BS network, CS1 network, and CS2 network, respectively. In the case of Digital Terrestrial (DT) broadcasting, different values of network ID are assigned to different broadcasters in a same area.

The service information part includes a service ID (so-called channel number) which is an identifier for identifying each individual service (channel) within a network.

An EIT describes program information for each event (so-called program) and is divided into a service information part and an event information part. The service information part includes a service ID (so-called channel number) which is an identifier for identifying each individual service (channel) within a network.

The event information part includes an event ID, a start time of the event, duration of the event, the name (so-called program title) of the event, category of the event, etc. A TOT describes current time.

While the above description concerns digital broadcasting that is put in operation in Japan, program information similar to the abovementioned service information is transmitted as well in digital broadcasting that is put in operation in different countries. Hence, the present invention which will be described hereinafter is applicable to digital broadcasting in different countries.

A first embodiment pertaining to the present invention is described below.

### [System Architecture]

FIG. 1A is a block schematic diagram depicting an embodiment of a networked terminal system pertaining to a first embodiment.

The networked terminal system of the present embodiment is comprised of, for example, a television receiver 1, a television receiver 19, a wireless terminal 12, a wireless router 10, an external network 11, and a server 99. An example depicted is an instance when the user of a wireless terminal 12, which is a mobile communication terminal such as a mobile phone as an information communication terminal, watches a TV program on a television receiver 1 at a home, shop, etc., while taking the wireless terminal 12 in hand.

The wireless router 10 is provided with a wireless LAN function such as Wi-Fi and connectable to the external network 11 via a communication link. The wireless router 10 is also connected to the television receiver 1, wireless terminal 12, and external network 11 and the television receiver 1 or wireless terminal 12 can get information via Internet.

The wireless router 10 has two interfaces for LAN and WAN to which different IP addresses are assigned. To a WAN interface, a global IP address that is identifiable over Internet is assigned. To a LAN interface, a private IP address that is usable in a closed network is assigned. Also, the wireless router 10 is provided with a firewall function for putting a restriction on access from the external network 11 and a Network Address Port Translation (NAPT) function for converting a private address to a global address or converting a global address to a private address. Moreover, the wireless router 10 is provided with a function that associates and stores an access control list (ACL) and a device identification ID of each device such as the television receiver 1 into a storage; the ACL has a setting as to whether or not to permit communication from the server 99 to the television receiver 1 and communication from the television receiver 1 or the like to the server 99.

It is assumed that the wireless router 10 is connected with the television receiver 1 or television receiver 19 via a wired LAN or wireless LAN and connected with the wireless terminal 12 via a wireless LAN. Here, Wi-Fi is a wireless LAN (Local Area Network) standard formulated by a standard “IEEE 802.11a/IEEE 802.11b” of IEEE (Institute of Electrical and Electronics Engineers, U.S.).

The server 99 is a device that, in response to operational information from a wireless terminal 12 connected to the network, transmits control information to an electronic device that is to be controlled, such as a television receiver, set-top box, and digital video recorder, connected to the network. These controlled devices may include home electric appliances such as air-conditioners and lighting, home automation, etc., along with the electronic devices. In the present embodiment, descriptions are provided based on the system architecture in which the wireless terminal 12 and the television receiver 1 are connected to the network.

The server 99 is connected to the external network 11 and the wireless terminal 12 and the television receiver 1 can transmit and receive information to/from the server 99 connected to the external network 11 via the wireless router 10. It is also possible for the wireless terminal 12 to use a mobile communication network and connect to a communication network through a base station 18, so that the wireless terminal can transmit and receive information and receive content via the external network connected to the communication network.

Also, the server 99 has a function that correlates and stores a device identification ID of a device to be controlled such as the television receiver 1 and a port number on the device to be controlled to listen to an access request and transmits a port number mapped to a device to be controlled, selected from a list of stored devices to be controlled from which a selection can be made, and an access request to the wireless router 10.

The first embodiment pertaining to the present invention will be described below with reference to the drawings.

### [Hardware Structure of a Television Receiver]

FIG. 1B is an example of a structural diagram of the television receiver 1.

The television receiver 1 is connected to an antenna 38 and includes a tuner/demodulator 2, a signal separator 3, a control unit 5, a channel selection controller 6, an input unit 4, a storage 23, a memory 20, a superimposition unit 7, a display unit 8, a communication I/F 9, an audio decoder 39, a video decoder 40, a speaker 41, an audio output unit 42, and a video output unit 43, among others. Processing units of each component are interconnected via a bus 120.

In the television receiver 1, application programs can be stored in the storage 23 and the control unit 5 will load any of the application programs from the storage 23 into the memory 20 and execute it, so that various functions can be implemented.

To simplify explanation in the following description, descriptions are provided on the supposition that the functional units of various programs are the implementers of various functions which are implemented through the execution of each application program by the control unit 5.

The application programs may be stored in advance into the storage 23 before the shipment of the television receiver 1 or may be stored on a medium such as an optical medium like CD (Compact Disk), DVD (Digital Versatile Disk), etc. or a semiconductor memory and installed into the television receiver 1 via a medium connector which is not depicted.

They can also be downloaded from the external network 11 via the communication I/F 9 and the wireless router 10 and installed.

The various functions of the application programs can also be implemented by hardware as processing units having the corresponding functions. In the case of hardware implementation, the respective processing units are the implementers of the respective functions.

The input unit 4 accepts an operational input from a user to the television receiver 1 and control information on input operation is input through it; it is implemented with, for example, a remote controller, a keyboard, a pointing device such as a mouse, etc.

The control unit 5 receives an operational request by the user via the input unit 4 and controls each of the following blocks: signal separator 3, channel selection controller 6, storage 23, superimposition unit 7, communication I/F 9, and functional units of various programs.

The storage 23 is controlled by an instruction given by the control unit 5 and is capable of storing application programs. It also stores varieties of information created by the application programs. Also, it may store content such as video and audio streams from signals received from the tuner/demodulator 2 or communication I/F 9.

The memory 20 is controlled by an instruction given by the control unit 5. Functional units of the application programs being stored in the storage 23 are loaded into the memory 20.

By tuning in a channel of a desired service under control of the channel selection controller 6, the tuner/demodulator 2 receives broadcast signals from a broadcasting station 999 and demodulates the received broadcast signals into a transport stream.

The channel selection controller 6 receives an instruction to select a channel of a service via the input unit 4 and controls the tuner/demodulator 2 to switch to a channel that should be selected according to the instruction. Also, the channel selection controller 6 can receive an instruction from the functional units of various programs and controls the tuner/demodulator 2 to switch to a service (channel number) broadcasting an event (program) that is now on air and a broadcast offering unit to which the service belongs.

The communication I/F 9 is connected to the wireless router 10 over a wired LAN 122 or wireless LAN. In addition to or alternatively to a function of communication with the wireless router 10, the communication I/F 9 may be configured to communicate with an external device directly without the intervention of the wireless router 10, through a method such as wireless LAN like Wi-Fi (a registered trademark), IrDA (a registered trademark), Bluetooth (a registered trademark), or NFC (Near Field Communication). The communication I/F 9 may be equipped with respective chips for carrying out different communication schemes. It may be equipped with a single chip for handling a plurality of communication schemes. The following will describe an example in which the communication I/F 9 transmits and receives varieties of information to/from the wireless terminal 12 via the wireless router 10, external network 11, and server 99. It is also possible to receive content streams (video and audio streams) in form such as IP broadcasts and video on demand like IPTV services from a server connected to the external network. It is also possible to download video streams and an application program from a server connected to the external network. Downloaded information is stored into, for example, the storage 23.

The signal separator 3 separates data in a transport stream obtained through the tuner/demodulator 2 and in a content stream obtained via the communication I/F 9 into video data, audio data, caption text data, program information, etc. according to type. It also has a function that obtains program information (e.g., service information SI) and transmits this information to other processing blocks. When having received a request to transmit data from any of other processing units, the signal separator transmits specified data to the requestor.

The audio decoder 39 decodes audio data separated by the signal separator 3. Audio information decoded by the audio decoder 39 is output from the speaker 41. Audio information decoded by the audio decoder 39 may also be output to an external device from the audio output unit 42.

The video decoder 40 decodes video data separated by the signal separator 3. Video information decoded by the video decoder 40 is sent to the superimposition unit 7.

On decoded video information that is transmitted from the video decoder 40, the superimposition unit 7 superimposes an EPG image and an OSD image created by the functional units of various programs and an image generated from varieties of information (captioning information, subtitles, data from data broadcasting, etc.) separated by the signal separator 3, among others. Video information processed through the superimposition unit 7 is displayed on the display unit 8.

The display unit 8 is configured using, e.g., the display of a television or a personal computer or a liquid crystal panel or the like and performs displaying broadcasted or distributed images, UI allowing to perform various operations, images stored in the storage 23, etc.

Video information processed through the superimposition unit 7 may also be output to an external device from the video output unit 43. Images that are to be displayed may be images created by an application program, images of content received via the tuner/demodulator 2, images received via the communication I/F 9 from a server in the external network 11, or images received via the communication I/F 9 from the wireless terminal 12.

Besides, a digital I/F 44 may be provided to output video and audio data from a transport stream of a given program separated by the signal separator 3 without decoding them.

The components of the television receiver 19 are the same as those of the television receiver 1 and, therefore, their description is omitted here. Although an example in which a television receiver is used is described in the present embodiment, the present embodiment can also be carried out by another hardware arrangement that employs a recorder and dispenses with the display unit and speaker with an externally connected television receiver or display and speaker used to provide images and sound in the same way. Although the hardware 1 is described as a television receiver in the present embodiment, it can be replaced by an STB, a recorder, or the like; in this case, the speaker 41 and the display unit 8 can be removed from the television receiver structure in FIG. 1B.

### [Hardware Structure of a Wireless Terminal]

FIG. 1C is an example of a structural diagram of the wireless terminal 12.

The wireless terminal 12 is, for example, comprised of a communication I/F 13, a control unit 14, a display unit 17, an input unit 15, a signal separator 21, a tuner/demodulator 22, a storage 25, a mobile communication I/F 31, a memory 43, an acceleration sensor unit 33, a geomagnetic sensor unit 34, a GPS receiver unit 35, and a gyro sensor unit 36 and processing units of each component are interconnected via a bus 121.

In the wireless terminal 12, application programs are stored in the storage 25 and the control unit 14 will load any of the application programs from the storage 25 into the memory 32 and execute it, so that various functions can be implemented. To simplify explanation in the following description, descriptions are provided on the supposition that the functional units of various programs are the implementers of various functions which are implemented through the execution of each application program by the control unit 14.

The application programs may be stored in advance into the storage 25 before the shipment of the wireless terminal 12 or may be stored on a medium such as an optical medium like CD (Compact Disk), DVD (Digital Versatile Disk), etc. or a semiconductor memory and installed into the wireless terminal 12 via a medium connector which is not depicted. They can also be downloaded from the external network 11 via the communication I/F 13 and the wireless router 10 and installed. Alternatively, they may be downloaded from a distributor via the mobile communication I/F 31 and via the base station 18 and installed. It is also possible to connect the wireless terminal 12 to a personal computer (PC) that obtained application programs over a network via an external device connection I/F which is not depicted, move or copy the programs from the PC to the wireless terminal 12, and install them.

The various functions of the application programs can also be implemented by hardware as processing units having the corresponding functions. In the case of hardware implementation, the respective processing units are the implementers of the respective functions.

The communication I/F 13 is connected to the wireless router 10 over a wireless LAN or the like. Also, the communication I/F 13 is connected to the external network via the wireless router 10 and transmits and receives information to/from the server 99 or the like in the external network. In addition to or alternatively to a function of communication with the wireless router 10, the communication I/F 13 is capable of communicating with the server 99 directly without the intervention of the wireless router 10 through a method such as wireless LAN like Wi-Fi (a registered trademark). The communication I/F may be equipped with respective chips for carrying out different communication schemes. It may be equipped with a single chip for handling a plurality of communication schemes. The mobile communication I/F 31 is connected to a communication network via the base station 18 and can transmit and receive information to/from a server in the communication network through the use of a mobile communication network based on GSM (a registered trademark) (Global System for Mobile Communications), based on a third-generation mobile communication system (hereinafter referred to as “3G”) such as W-CDMA (Wideband Code Division Multiple Access), CDMA 2000, and UMTS (Universal Mobile Telecommunications System), or based on LET (Long Term Evolution). An arrangement can be made so that connection to the external network by the communication I/F 13 takes precedence over connection to a communication network by the mobile communication I/F 31.

The control unit 14 receives an operational request by the user via the input unit 15 and controls the signal separator 21, display unit 17, communication I/F 13, and functional units of various programs.

Besides, the control unit 14 has a function capable of obtaining varieties of information from the server 99 in the external network 11 via the communication I/F 13 and the wireless router 10 or via the mobile communication I/F 31 and the base station 18 and passing such information to the functional units of various programs.

The storage 25 is controlled by an instruction given by the control unit 14 and is capable of storing application programs. It also stores varieties of information created by the application programs. Also, it may store content such as video and audio streams from signals received from the tuner/demodulator 22, communication I/F 13, or mobile communication I/F 31.

The memory 32 is controlled by an instruction given by the control unit 14. Functional units of the application programs being stored in the storage 23 are loaded into the memory 32 by the control unit 14.

The display unit 17 displays images stored in the storage 25, broadcasted or distributed images, UI allowing performing various operations, a browser display screen created by a browser engine 1102 which will be described later, etc. Images that are to be displayed may be images created by an application program, images of content received via the tuner/demodulator 22, images received via the communication I/F 13 from a server in the external network, images received via the communication I/F 13 from the television receiver 1 or images received via the mobile communication I/F 31 from a server in a communication network. The display unit 17 may be configured integrally with, e.g., a touch panel or the like as mentioned below.

The input unit 15 accepts an operational input from a user to the wireless terminal 12 and control information on input operation is input through it; for the input unit, for example, physical buttons or a touch panel among others can be employed. Although an example in which a touch panel was employed is described below in the present embodiment, the input unit may be configured using physical buttons for various operations.

Using the touch panel, the user can freely move an optional object (icon) or the like on the tough panel by moving the object or the like, while touching it with a fingertip (dragging) or flicking the object or the like with a fingertip to move it on the screen (flicking). Also, the user can activate an object (icon) or the like or switch to another screen by tapping the object or the like once (tapping) or tapping it twice (double tapping). In the present embodiment, user actions on the above touch panel are called dragging, flicking, and tapping in description.

The tuner/demodulator 22 and the signal separator 21 serve like the tuner/demodulator 2 and the signal separator 3 in the television receiver 1, respectively. Because their functions were described previously, repeated description is omitted.

The acceleration sensor unit 33 takes a measurement of acceleration exerted on the wireless terminal 12. For example, the control unit 14 can know which side of the wireless terminal 12 is upper according to a measurement of gravitational acceleration taken by the acceleration sensor unit 33 and causes the display unit 17 to display a screen in alignment with the orientation of the wireless terminal 12 hand-held by the user by aligning the upper side of the screen with the upper side known by the measurement taken by the acceleration sensor unit.

The geomagnetic sensor unit 34 takes a geomagnetic measurement in such a way as using a plurality of magnetic sensors.

The GPS receiver unit 35 receives signals that are transmitted from a plurality of satellites using a GPS (Global Positioning System). The control unit 14 can calculate location information of the wireless terminal 12 based on the signals received by the GPS receiver unit 35.

The gyro sensor unit 36 takes a measurement of angular velocity that is produced, as the user moves the wireless terminal 12.

### [Hardware Structure of a Server]

FIG. 1D is an example of a structural diagram of the server 99.

The server 99 is comprised of, for example, a communication I/F 50, a control unit 51, a memory 52, and a storage 53 and processing units of each component are interconnected via a bus 123.

In the server 99, application programs are stored in the storage 53 and the control unit 51 will load any of the application programs from the storage 53 into the memory 52 and execute it, so that various functions can be implemented. To simplify explanation in the following description, descriptions are provided on the supposition that the functional units of various programs are the implementers of various functions which are implemented through the execution of each application program by the control unit 51.

The communication I/F 50 is connected to the external network 11 and connected to the wireless router 10 over the external network 11. The communication I/F 50 transmits and receives varieties of information to/from the communication I/F 9 of the television receiver 1 or the communication I/F 13 of the wireless terminal 12.

The control unit 51 controls the communication I/F 50, memory 52, storage 53, and functional units of various programs. Besides, the control unit 51 has a function of transferring content accumulated in the storage 53 to the communication I/F 50 and further to the television receiver 1 or the wireless terminal 12 over the external network 11.

The storage 53 is controlled by an instruction given by the control unit 51 and is capable of storing application programs. It also stores varieties of information created by the application programs. It also has a function of accumulating, inter alfa, device control information and user authentication information in a device control information database and a user authentication database, respectively.

The memory 52 is controlled by an instruction given by the control unit 51. Functional units of the application programs being stored in the storage 53 are loaded into the memory 52 by the control unit 51.

### [Software Structure of a Television Receiver]

FIG. 2A depicts the storage 23 and the memory 20 drawn from the structure of the television receiver 1 in FIG. 1B. FIG. 2A depicts a state in which the storage 23 stores a device authentication program 1001 and a control interface program 1002 and the control unit 5 has loaded the device authentication program 1001 and the control interface program 1002 into the memory 20 as a device authentication unit 1004 and a control interface unit 1005. The device authentication program 1001 and the control interface program 1002 may have already been stored in the storage 23 at the time of shipment of the product or may be downloaded via the communication I/F 9.

To simplify explanation in the following description, descriptions are provided on the supposition that the functional units of various programs are the implementers of various functions which are implemented through the execution of each application program by the control unit 5.

In the television receiver 1, it is assumed that device authentication information such as a device ID and a device password which were set through input by the user using the input unit 4 or set in advance before factory shipment or the like of the television receiver 1 is stored as device authentication information 1003 in the storage 23 and the device authentication unit 1004 can refer to this information, when performing device authentication. It is also assumed that such device authentication information can be confirmed by the user by displaying that information on the display unit 8 through a user operation or by reference to an attached document or the like provided when the user purchased the television receiver 1.

The device authentication unit 1004 compares device authentication information comprised of a device ID and a device password stored as the device authentication information 1003 with device authentication information transmitted from the server 99 and, if both information pieces of device authentication information match, permits the server 99 to connect to the television receiver. Otherwise, if these pieces of device authentication information are erroneous, the device authentication unit 1004 does not accept a connection from the server 99.

The control interface unit 1005 is executed by the control interface program 1002 including API (Application Program Interface) software for passing control information from the server 99 to a process internal to the television receiver 1. The API software is interface software for control processing on each device to be controlled, serves as an input unit for passing control information from the server 99 to an internal process, and is generally provided as control functions.

The system additionally has a function in which a confirmation is made by the server 99 as to whether or not API software or a version required for control has been installed in a television receiver according to the device ID of the television receiver 1 and downloading software from the server 99 is performed if necessary. Details will be described later in a third embodiment section.

### [Software Structure of a Wireless Terminal]

FIG. 2B depicts the storage 25 and the memory 32 drawn from the structure of the wireless terminal 12 in FIG. 10. FIG. 2B depicts a state in which the storage 25 stores a browser program 1101 and the control unit 14 has loaded the browser program 1101 into the memory 32 as a browser engine 1102. The browser program may 1101 have already been stored in the storage 25 at the time of shipment of the product or may be downloaded via the communication I/F 13 or the mobile communication I/F 31. Although operation by the browser program is described in the present embodiment, an application program other than the browser may be used.

To simplify explanation in the following description, descriptions are provided on the supposition that the functional units of various programs are the implementers of various functions which are implemented through the execution of each application program by the control unit 14.

The browser engine 1102 is comprised of the following functional blocks: an HTML parser 1103, a database creating unit 1104, a rendering unit 1105, and an image processing unit 1106.

The HTML parser 1103 analyzes a logical structure of HTML data obtained via a network controller and the control unit 5. It is also capable of interpreting the obtained HTML data and converting it to internal data that is used in the television receiver 1.

The database creating unit 1104 creates a database relevant to the HTML data structure.

The rendering unit 1105 creates a layout structure including information on a representation form determined per tag, based on the database and creates a browser display screen according to input data of size, position, and images, based on the layout structure.

The image processing unit 1106 places image files as specified by image tags in the HTML data and converts the image files obtained based on image file information such as image file names into image data of a bitmap form or the like.

### [Software Structure of Server]

FIG. 2C depicts the storage 53 and the memory 52 drawn from the structure of the server 99 in FIG. 10. In FIG. 2C, the storage 53 stores a user management program 1201, a device control program 1202, a device management program 1203, and a device operation screen creating program 1204 and the control unit 51 loads the user management program 1201, device control program 1202, device management program 1203, and device operation screen creating program 1204 into the memory 52 as a user management unit 1208, a device control unit 1209, a device management unit 1210, and a device operation screen creating unit 1211. By executing the above programs by the control unit 51, various functions can be implemented. The user management program 1201, device control program 1202, device management program 1203, and device operation screen creating program 1204 can be stored in advance from an external storage or the like.

To simplify explanation in the following description, descriptions are provided on the supposition that the functional units of various programs are the implementers of various functions which are implemented through the execution of each application program by the control unit 51.

The user management unit 1208 manages, inter alia, user authentication information for authenticating each user and device authentication information for authenticating a device owned by a user. User authentication information and device authentication information are stored as user authentication information 1205 and device management information 1207, respectively, in the storage 53. Via the communication I/F 50 and over the external network 11, the user management unit 1208 obtains user authentication information, in particular, a user name and a password entered by the user of the wireless terminal 12 through the input unit 15 and makes sure whether the user is a legitimate registered user. It has a function that returns error information if the user authentication information is incorrect. The device control unit 1209 implements device control as follows: based on operation information from the wireless terminal 12, the device control unit 1209 looks for an appropriate one of control commands, control protocols, etc. accumulated as device control information 1206 in the storage 53, which is required for a controlled device such as the television receiver 1, and transmits it to the controlled device via the communication I/F 50 and over the external network 11. It also receives information relevant to the current device state and software state from the controlled device and can indicate to the user that a key or the like that is now made disabled in consequence of the state of the controlled device is inoperable by changing its display color or the like. In response to a certain state of the controlled device, it also can present error information to the user by sending information relevant to an error to be displayed on the display unit of the controlled device.

The device operation screen creating unit 1211 creates device operation panel information for displaying a device operation screen on the display unit 17 of the wireless terminal 12. Via the communication I/F 50 and over the external network 11, device operation panel information is transmitted to the wireless terminal 12 and the wireless terminal 12 displays a device operation screen on the display unit 17 based on the device operation panel information. Panel operation information selected by the user of the wireless terminal 12 through the input unit 15 is transferred to the device control unit over the external network 11 and via the communication I/F 50.

### [Data Forms]

FIG. 3A is a data table representing an example of contents of user authentication information 1205 that is managed by the user management unit 1208 on the server 99. In the user authentication information 1205 that is managed by the user management unit 1208, user ID (management number) 101, password 102, unique user name 103, full name, address, and contact, among others, are stored. Although descriptions in the present embodiment assume that a user is authenticated by his or her password, a user may be authenticated by general biometric authentication or the like using finger vein, fingerprint, voice, face image, iris, etc.; in the latter case, an item of user authentication information changes accordingly.

FIG. 3B is a data table representing an example of contents of device management information 1207 that is managed by the device management unit 1210 on the server 99. In the device management information 1207 that is managed by the device management unit 1210, user ID (management number) 101, device No. 104, device name 105, device ID 106, device password 107, device IP address 108, etc. are stored.

Device No. 104 represents a serial number beginning with 1 for distinguishing a device. Device name 105 represents a device name selected by user from a controlled device list in which controlled devices are listed on a per-manufacturer basis or entered by user optionally. Device ID 106 represents a device ID for uniquely identifying a device that the user uses; the device ID can be confirmed from a label attached to the device and a menu setting screen among others and is set by user. Device password 107 is a password that is used for authentication when controlling the device and can be specified optionally by user. Device IP address 108 represents a private IP address assigned to a controlled device. In the present embodiment, it is represented that a user with ID “0000101” in a column of user ID 101 owns devices 1 to 3 which are given in a column of device No.

104.

FIG. 4 represents a setting example of an access list that is set in advance on the wireless router 10 for permitting access from a server 99. Access list setting is comprised of server IP address 109, protocol 110, and port No. 111. In a column of server IP address 109, a global IP address of a server 99 is set. In a column of protocol 110, a protocol type TCP or UDP as a communication protocol that is used at the side of a server 99 or a controlled device is set. In a column of port No. 111, port numbers for use on the server 99 are set.

When accessed from a server 99 connected to a WAN, the wireless router 10 refers to the access list and permits communication with a device connected to a LAN, if the global IP address of the server 99 along with a protocol or port numbers is registered in the access list.

FIG. 5 represents a setting example of NAPT that is set on the wireless router 10. NAPT setting is comprised of device IP address 112 which is set per controlled device, protocol 113, port No. for LAN 114, and port No. for WAN 115.

In a column of device IP address 112, a private IP address assigned to a controlled device is set. In a column of protocol 113, a protocol type TCP or UDP as a communication protocol is set. In a column of port No. for LAN 114, a private port number that a controlled device allocates is set. In a column of port No. for WAN 115, a global port number that the wireless router 10 allocates is set.

Referring to the NAPT setting, the wireless router 10 transmits a packet incoming from a server 99 to a controlled device with a private IP address identified according to a destination global port number included in the packet. For a packet transmitted from a controlled device, the wireless router 10 converts a source private IP address to a global IP address and transmits the packet to an appropriate server 99. Here, although a private port number for LAN and a global port number for WAN are identical in the present embodiment, different port numbers may be allocated.

### [Operation Sequence]

FIG. 6 is a diagram illustrating an example of an operation sequence pertaining to the first embodiment. Descriptions are also provided for a relation between a screen display example and processing by way of FIGS. 7 to 12.

FIG. 7 depicts a display example of a menu screen on the wireless terminal 12.

In FIG. 7, when the user taps “Remote Control” 202 in the menu screen 201, the control unit 14 of the wireless terminal 12 receives a command to start up the browser from the input unit 15 and starts up the browser engine 1102 (S2001). The browser engine 1102 gets access to a portal for remote control, which has been set in advance, of the server 99.

Then, the browser engine 1102 transmits a request message for requesting resources of screen information such as login information, compliant with HTTP, via the control unit 14, communication I/F 13, and wireless router 10, further over the external network 11, to the server 99.

The server 99 creates and returns a response message in reply to the request message received. Over the external network 11, the returned response message is input to the browser engine 1102. An HTML document is embedded in the response message and a browser display screen is created by the HTML parser 1103, database creating unit 104, rendering unit 1105, and image processing unit 1106 of the browser engine 1102. As seen in FIG. 8, on the display unit 17, a display is made of a login screen to log in the portal for remote control (S2002). FIG. 8 depicts a display example of a login screen on the wireless terminal 12.

The control unit 14 of the wireless terminal 12 gives an instruction and passes login information, namely, a user name and a password entered through the input unit 15 to the browser engine 1102 which in turn transmits character strings received as a request message to the server 99 (S2003).

On the server 99, the user management unit 1208 refers to user authentication information 1205 in the storage 53 and authenticates the user if the user is a legitimate registered user (S2004). If a controlled device is not yet set, the server 99 returns controlled device setting screen information as a response message to the browser engine 1102 (S2005). Upon receiving the response message, the browser engine 1102 displays a controlled device setting screen 207 which is as depicted in FIG. 9 on the display unit 17 (S2006).

FIG. 9 depicts a display example of the controlled device setting screen on the wireless terminal 12.

In FIG. 9, a “New” tab 208 in a displayed box of controlled device setting screen 207 represents a tab for selecting a device that the user wants to control newly and a mark 209 indicates that the user can select a next level of hierarchy by tapping the “New” tab 208. An “Edit” button 210 is used to modify or delete a setting that has once been set. When the user taps the “New” tab 208, a device detail setting screen 211 which is as depicted in FIG. 10 is displayed. FIG. 10 depicts a display example of the device detail setting screen on the wireless terminal 12.

In FIG. 10, a “Device” tab 212 is a field in which displayed are a device manufacturer and a device name selected by user through a GUI of a pull-down form, a checkbox form, etc. from a controlled device list 1216 in which controlled devices are listed on a per-manufacturer basis, though not depicted. The controlled device list 1216 is stored in the storage 53 of the server 99. If a new device that might be controlled is put on the market from a manufacturer, its manufacturer name and device name are added to the controlled device list. In the present embodiment, a setting example is presented in which a model “L42-XP02 of Company A” is registered as device 1.

The “Device ID” tab 213 shows identification ID for uniquely identifying a device that the user uses. Identification ID can be confirmed from a label attached to the device and the menu setting screen among others and is entered by user through the input unit 15. A “Device Password” tab 214 is a password that is used for authentication when controlling the device and can be specified optionally by user through the input unit 15.

An “IP Address” tab 215 shows the IP address of the controlled device, which is set by user through the input unit 15.

Now, instead of setting a device in the “Device” tab 212, it is also possible to obtain a “device ID” by using a controlled devices database associated with “device IDs” stored in the device management information 1207 and automatically set a “device”. As an example of use, if a device that the user wants to set as a controlled device is not found in the controlled device list, or if the user wants to make the setting work easy, by selecting “Automatic” as a device name in the “Device” tab 212, then the server 99 can set a recommended model automatically, as described above.

Next, when the user taps an “Operation Check” button 216, device setting information entered through the input unit 15 and displayed in the “Device” tab 212, “Device ID” tab 213, “Device Password” tab 214, “IP Address” tab 215 is transmitted to the server via the communication I/F 13 or mobile communication I/F 31 (S2007).

Upon receiving the device setting information from the wireless terminal 12, the server 99 transmits device authentication information comprised of the device ID and the device password which were set in the device control information to the device authentication unit 1004 on the television receiver 1 (S2008). The device authentication unit 1004 compares authentication information stored in advance as the device authentication information 1003 with the authentication information transmitted from the server 99 and, if both information pieces of authentication information match, permits the server 99 to connect to the television receiver by sending back an authentication response (S2009).

Then, the server 99 transmits control information for testing to the television receiver 1 (S2010). The television receiver 1 having received the control information for testing returns a device control information response to the server 99, if it properly received the control information for testing and a proper operation was performed (S2011).

Once the server 99 has been permitted by the television receiver 1 to connect to the television receiver and has received a normal response to the control information for testing, the server 99 assigns a device No. 104 to the television receiver and stores information included in the login information received at step 2003 and the controlled device setting information received at step S2007, as device setting information on device 1, into the database of device management information 1207 on the server 99 according to the data form depicted in FIG. 3 in association with the logged-in user. FIG. 11 depicts a display example of a device setting screen in which devices 1 to 3 have been set on the wireless terminal 12.

FIG. 11 depicts a state in which devices 1 to 3 are set in a “Device 1” tab 217, “Device 2” tab 218, and “Device 3” tab 219 according to the foregoing procedure. When the user taps an “End” button, the device setting screen 200 closes.

If, at step 2008 or step 2010, a device authentication response or a device control information response cannot be received within a predetermined period for a reason, such as because the AC power supply of the television receiver 1 is off, or if error information is returned because of improper operation, it may be arranged to display an error indication to the user and recheck the setting on the controlled device setting information, returning to step 2006 again.

Next, the server 99 transmits operation screen information to the wireless terminal 12 (S2012) and the wireless terminal 12 displays an operation screen 22 which is as depicted in FIG. 12 (S2013). FIG. 12 depicts a display example of the operation screen on the wireless terminal 12.

Operation screen information created per controlled device is prepared. The server identifies a controlled device based on the device ID 106 of the controlled device transmitted at step S2007 and operation screen information created for the identified device is transmitted. In the operation screen information, included is operation information to be transmitted to the server 99 when a button on display is selected.

Operation screen information is stored on a mobile terminal at initial setting or at first-time operation and managed per controlled device. By using the operation screen information stored on the mobile terminal, next time the operation screen is displayed, a communication traffic volume is reduced and, besides, time taken before the start of operation can be shortened.

On the operation screen 221 in FIGS. 12(a) and 12(b), Device 1 (television receiver 1) 222, Device 2 ((television receiver 2) 223, and Device 3 (BD recorder) 224 are displayed as “device selection” buttons, each of which shows a device name or device icon or the like corresponding to device No. 104 presented in FIG. 3B. When the user taps and selects one of the “device selection” buttons, operation buttons 225, 226 for the selected device are displayed. A selected “device selection” button may be displayed with its display color changed to distinguish it from other devices which are not selected.

By flicking the operation screen 221 to right or left, the user can switch to another operation screen with operation buttons. By flicking the screen depicted in FIG. 12A leftward, the user can switch to the operation screen which is as depicted in FIG. 12 (b). By doing so reversely, the user can return to the operation screen in FIG. 12A from that in FIG. 12B. Although two operation screens are presented in the present embodiment, it is also possible to have a plurality of operation screens for each device.

It is also possible to change the layout of buttons on an operation screen according to the user's preference and rearrange the buttons automatically or manually in descending order of frequency in use. A “triangle mark” 227 is used to exit the operation screen. By tapping the “triangle mark” 227, the operation screen closes and the user can return to a menu screen depicted in FIG. 7. Information representing a change made to the layout of buttons on an operation screen or other changes is transmitted to the server and managed per user in association with information relevant to users stored in the database of user management information and a changed operation screen is transmitted from the server when operating the same device next time and later. If an operation screen has been stored on a mobile terminal and a change is made to the screen, the changed operation screen is stored on the mobile terminal itself.

In FIG. 12A, by way of example, when the user taps and selects a “Power” button 225 through the input unit 15 (S2014), the wireless terminal transmits operation information of the “Power” button 225 to the server 99 (S2015). The server 99 stores in advance an association of operation information with a control command or the like that will be transmitted to a controlled device. When receiving the operation information of the “Power” button 225, the server generates control information such as a control command for the device associated with the “Power” button (S2016) and transmits the generated control information to the television receiver 1 (S2017). Operation information may be information by which the server 99 can know the function of an operation button selected through the input unit 15, such as information on relative positions in which operation buttons are displayed on the display unit 17 of the wireless terminal 12 and link information linked to the operation buttons. Besides, identification information of the controlled device selected with one of the “device selection” buttons 222 to 224 can be added to operation information. This is effective for preventing erroneous judgment because of state inconsistency between the wireless terminal 12 and the server 99.

Upon receiving the control information, the television receiver 1 judges whether the control information is valid (S2018). If the control information is not valid (S2018: NO), the television receiver transmits error information to the server 99. Upon receiving the error information, the server 99 transmits the error information to the wireless terminal 12. If an “operation” button is ineffective in consequence of the state of the device, the server 99 may indicate to the user that the “operation” button is inactive by changing its color to another color such as gray. If the control information is valid (S2018: YES), the television receiver returns a response indicating that it responded to operation control (S2020).

Here, the television receiver 1 may be equipped with, e.g., a WOL (Wake On LAN) function. Even if a networking function of the television receiver 1 is placed in a standby state, the networking function of the television receiver 1 can be started up by transmitting a magic packet including a MAC address of the television receiver from the server 99 via the wireless router prior to device authentication at step S2008 or transmitting control information at step S2017.

In some situations, the wireless terminal can connect to an external network by the communication I/F 13 and connect to a communication network by the mobile communication I/F 31 at the same time. For such an occasion, the wireless terminal may be provided with a switching means for preferentially switching to the connection to the external network by the communication I/F 13. In the case of connection to a communication network by the mobile communication I/F 31, doing an unnecessary operation by using the wireless terminal from an outdoor place can be prevented by limiting the functions that can be operated on an operation screen in processing at step S2012 and subsequent steps or displaying a message. It may be arranged that a controlled device in a home can be controlled from an operation screen only when the wireless terminal connects to the external network by the communication I/F 13.

In a case where interlock operation of a plurality of devices is desired, for example, such as a case where, when a playback button of a recorder is selected, the power of a television receiver 1 is turned on and switching to a predetermined video input occurs, such operation can be implemented by user setting with a GUI for defining operations that the user wants to interlock.

As described above, in a case where a device such as a television receiver is remotely controlled and operated, it is possible to remotely control and operate a plurality of controlled devices with ease from a wireless terminal without installing a special application in the wireless terminal. An operation screen can be customized independently of a controlled device or a mobile terminal, a device can be operated with a preferred operation screen, and usability is improved.

### Second Embodiment

In the following, a second embodiment pertaining to the present invention is described with FIGS. 6, 7, 12, and 13. The following description highlights differences in comparison with the first embodiment. The system architecture and software structure are the same as in the first embodiment and, thus, their descriptions are omitted.

### [Operation Sequence]

FIG. 13 is a diagram illustrating an example of an operation sequence pertaining to the second embodiment. Descriptions are also provided for a relation between a screen display example and processing by way of FIG. 12.

Steps S3001 and S3002 are added to FIG. 6 for the first embodiment, instead of steps S2005 to S2007. In the present embodiment, descriptions are provided for a case where controlled device setting has already been performed.

In FIG. 7, as is the case for the first embodiment, when the user taps “Remote Control” 202 on the menu screen 201, the control unit 14 of the wireless terminal 12 receives a command to start up the browser from the input unit 15 and starts up the browser engine 1102, the browser engine 1102 gets access to a portal for remote control, which has been set in advance, of the server 99, and a display is made of a login screen to log in the portal on the display unit 17 (S2001 to S2002).

The control unit 14 of the wireless terminal 12 gives an instruction and passes login information, namely, a user name and a password entered through the input unit 15 to the browser engine 1102 which in turn transmits character strings received as a request message to the server 99 (S2003). On the server 99, the user management unit 1208 refers to user authentication information 1205 in the storage 53 and authenticates the user if the user is a legitimate registered user (S2004).

Next, to check registered device information and perform an authentication operation, the server 99 retrieves a registered device from device setting information for the logged-in user stored in the database of device management information 1207 in the storage 53 and performs device authentication of each registered device based on the device ID and device password (S3001, S3002). Here, if there is no response to device control, for example, because the AC power supply of the device is off in spite of the registered device, the server may indicate to the user that this device is now placed in an uncontrollable state by changing the display color of the corresponding device selection button 222, 223, or 224 to another color such as gray. If a plurality of devices are registered, authentication of these devices can be performed by repeating the procedure of steps 3001 and 3002 in order.

Once the server 99 has been permitted to connect to the television receiver, the server transmits operation screen information to the wireless terminal 12 (S2012) and the wireless terminal 12 displays an operation screen which is as depicted in FIG. 12 on the display unit 17 (S2013).

Because subsequent steps S2014 to S2020 are the same as in the first embodiment, their descriptions are omitted.

As described above, in a case where a device such as a television receiver is remotely controlled and operated, it is possible to remotely control and operate the device with ease from a wireless terminal by registering the controlled device in advance.

### Third Embodiment

In the following, a third embodiment pertaining to the present invention is described with FIGS. 2(c), 13, and 14. The following description highlights differences in comparison with the second embodiment. The system architecture and software structure are the same as in the first embodiment and, thus, their descriptions are omitted.

### [Operation Sequence]

FIG. 14 is a diagram illustrating an example of an operation sequence pertaining to the third embodiment. Steps S3011 to 2013 are added to FIG. 13 for the second embodiment. In the present embodiment, descriptions are provided for a case where controlled device setting has already been performed.

Processing steps of starting up the browser screen (S2001) up to user authentication (S2004) are the same as described with FIG. 13 for the second embodiment and thus are omitted.

In the present embodiment, descriptions are provided for a case where a function was added in which the server 99 releases API software required for operating the television receiver 1 to the television receiver 1 and confirms whether or not API software or a version required for control has been installed in a television receiver according to the device ID of the television receiver 1 and downloading software from the server 99 is performed if necessary.

In FIG. 14, to check registered device information and perform an authentication operation, the server 99 retrieves a registered device of the logged-in user from the database of device management information 1207 stored in the storage 53 and performs device authentication of each registered device based on the device ID and device password (S3001). In the database of varieties of data depicted in FIG. 2A, API software information is stored, such as information as to whether or not API software has been installed in each device and version information, which are not involved with a direct management by user such as confirming and setting its contents.

The server 99 obtains a result of device authentication and a result of reference to API software information from the television receiver 1 as a registered device information response (S3002). If API software is not installed or its version is old in comparison with the latest version according to API software information, the server determines that downloading is needed (S3011: YES) and instructs the television receiver 1 to start downloading API software. The television receiver 1 may synchronize with the server 99 and start downloading automatically or may prompt the user to decide whether or not to start downloading before the start of downloading.

If downloading is not needed (S3011: NO), the steps S3012 and S3013 are skipped.

When API software downloading is complete (S3012: YES), the television receiver 1 API transmits an API download complete notification to the server 99 (S3013). Upon receiving the API download complete notification, the server 99 stores API software information such as information on a version downloaded by the television receiver 1 into the database of varieties of data and reflects it to operation screen information, operation information, etc. at next and subsequent steps.

Because subsequent steps S2012 to S2020 are the same as in the second embodiment, their descriptions are omitted.

As described above, by downloading API software to a television receiver if necessary, it is possible to remotely control and operate a television receiver with ease from a wireless terminal independently of a manufacturer and by easy operation and without installing a special application in the wireless terminal.

### Fourth Embodiment

In the following, descriptions are provided, taking as an example the server including a system that obtains program information from service information SI or metadata or the like from a broadcaster, a program information provider, etc. via the communication I/F 50 and over the external network 11 and creates an electronic program guide (EPG) listing of digital broadcasts based on the obtained service information.

In the following, a fourth embodiment pertaining to the present invention is described with FIGS. 1, 2, 11, and 15 to 20. The following description highlights differences in comparison with the second embodiment. The system architecture and software structure are the same as in the first embodiment and, thus, their descriptions are omitted.

### [Software Structure of a Server]

FIG. 15 depicts the storage 53 and the memory 52 drawn from the structure of the server 99 in FIG. 1D.

For the server 99 according to the present embodiment, in comparison with FIG. 2C, the storage 53 stores a program information obtaining program 1212 and a program information display screen creating program 1213 and the control unit 51 loads the program information obtaining program 1212 and the program information display screen creating program 1213 into the memory 52 as a program information obtaining unit 1214 and a program information display screen creating unit 1215. By executing the above programs by the control unit 51, various functions can be implemented.

To simplify explanation in the following description, descriptions are provided on the supposition that the functional units of various programs are the implementers of various functions which are implemented through the execution of each application program by the control unit 51.

The program information obtaining unit 1214 obtains program information from service information SI or metadata or the like from a broadcaster, a program information provider, etc. via the communication I/F 50 and over the external network and, based on the obtained program information, stores respective pieces of program information such as program titles and program detail information for each service ID (channel number) into the storage 53 according to temporal sequence.

The program information display screen creating unit 1215 creates an EPG in which service IDs are horizontally arrayed in the heading and cells for programs are placed from the top to down for each service ID according to temporal sequence, based on service information of the program information obtained by the program information obtaining unit 1214. In each program cell in the electronic program guide, some or all of information on each program such as detail of the contents of a program included in the service information can be placed.

The device control unit 1209, device management unit 1210, and device operation screen creating unit 1211 are the same as in the first embodiment and, thus, their descriptions are omitted.

### [Operation Sequence]

FIG. 16 is a diagram illustrating an example of an operation sequence pertaining to the fourth embodiment. Descriptions are also provided for a relation between a screen display example and processing by way of FIGS. 17 to 20.

Processing steps of starting up the browser screen (S2001) up to user authentication (S2004), registered device authentication (S3001), registered device authentication response (S3002), and deciding whether or not downloading is needed (S3011) up to API download complete notification (S3013) are the same as described with FIG. 13 for the second embodiment and thus are omitted.

FIG. 17 depicts a modification example of a device setting screen on the wireless terminal 12. In FIG. 17, a program guide function select tab 228 is added to the device setting screen 207 in FIG. 11. FIG. 18 depicts a display example of an operation screen on the wireless terminal 12. FIG. 18 highlights an “EPG” button 230 in contrast to FIG. 12B.

The program guide function select tab 228 is used for function setting of the “EPG” button 230 and allows the user to set up how to obtain an electronic program guide through a GUI of a pull-down form, a checkbox form, etc. Setup is possible as follows: for example, if the user selected “Internet”, an EPG created by the server 99 is obtained from Internet over the external network; and, if the user selected “device”, an EPG is created using information received by the wireless terminal 12 from broadcast waves or the like. FIG. 17 presents an example in which “Internet” is selected as the program guide function. An embodiment in a case of using an EPG created by the server 99 is described below.

In FIG. 16, the server 99 transmits operation screen information to the wireless terminal 12 (S2012) and the wireless terminal 12 displays an operation screen 221 which is as depicted in FIG. 18 on the display unit 17 (S2013). In FIG. 18, when the user taps and selects the “EPG” button 230 through the input unit 15 (S2014), the wireless terminal transmits operation information of the “EPG” button 230 to the server 99 (S2015). When receiving the operation information of the “EPG” button 230, the server 99 transmits EPG screen information created by the program information display screen creating unit 1215 based on program information obtained by the program information obtaining unit 1214 to the wireless terminal 12 (S3021). Based on the EPG screen information obtained from the server 99, the wireless terminal 12 displays an EPG screen 301 which is as depicted in FIG. 19 on the display unit 17 (S3022).

FIG. 19 depicts a display example of the EPG screen on the wireless terminal 12. In FIG. 19, a Network ID (DT: Digital Terrestrial, BS, CS, etc.) indicator indicates that “DT” broadcasting programs are now selected among a plurality of broadcasting networks. By touching a “Return” button 304, the user can return to the operation screen in FIG. 18.

In FIG. 19, a program “Goddess's Market” 303 that is now on air is selected by tapping it on the EPG screen 301 through the input unit 15 (S3023), the wireless terminal transmits selection operation information (program) including identification information identifying the selected program and a command to request detail information on the program identified by the identification information to the server 99 (S3024). Upon receiving the operation information including the identification information of the program “Goddess's Market” 303, the server 99 returns program detail screen information on the program identified by the identification information to the wireless terminal 12 (S3025). Based on the program detail screen information, the wireless terminal 12 displays a program detail screen 305 which is as depicted in FIG. 20 on the display unit. FIG. 20 depicts a display example of the program detail screen on the wireless terminal 12.

In FIG. 20, a “Watch” button 306 is used to watch the selected program on the television receiver 1. When this button is selected by tapping it, the wireless terminal transmits selection operation information (watch) including identification information identifying the selected program and a command to make a request for displaying the program identified by the identification information to the server 99 (S3026).

The server 99 converts the operation information of the program that is now on air, identified by the identification information, to channel selection information including uniquely identifiable information such as a network ID, a service ID, etc. (S3027) and transmits this channel selection information to the television receiver 1 (S3028).

Upon receiving channel selection information, the television receiver 1 judges whether the channel selection information is valid (S3029). If the channel selection information is not valid (S3029: NO), the television receiver transmits error information to the server 99. Upon receiving the error information, the server 99 transmits the error information to the wireless terminal (S3030). If the channel selection information is valid (S3029: YES), the television receiver performs a channel selection operation (S3031) and returns a response indicating that it responded to channel selection operation (S3032).

Here, in a case where a program that is selected is scheduled to be on air in time to come, the television receiver 1 can be adapted to make a reservation of the program to watch or to be recorded, based on the channel selection information. In the case of reservation conflicts or reserving programs to be recorded, by returning status information such as the remaining capacity of a hard disk to the server 99 at step 3032, an error display or the like may be presented on the wireless terminal 12.

As described above, the user can not only select a channel using a channel selection button on a remote controller but make a channel selection or a program reservation by using a program guide. When being out of home, the user can perform remote operation in the same way of operation from an outdoor place.

The present invention is not limited to the embodiments described hereinbefore and various modifications are included therein. For example, the foregoing embodiments are those in which the whole system was described in detail to explain the present invention clearly and the invention is not necessarily limited to those including all components described. A part of the configuration of an embodiment can be replaced by the configuration of another embodiment. To the configuration of an embodiment, the configuration of another embodiment can be added. As for a part of the configuration of each embodiment, another configuration can be added to it or it can be removed and replaced by another configuration.

A subset or all of the components, functions, processing units, processing means etc. described hereinbefore may be implemented by hardware, for example, such as designing them with an integrated circuit. The components, functions, etc. described hereinbefore may be implemented by software in such a way that a processor interrupts and executes programs that implement their functions. Information such as programs that implement the functions, tables, and files can be placed in a recording device such as a memory, hard disk, and SSD (Solid State Driver) or a recording medium such as an IC card, SD card, and DVD.

Control lines and information lines considered as necessary for explanation are depicted and they do not necessarily represent all control lines and information lines in terms of an article of manufacture. Actually, nearly all components may be considered to be interconnected.

In the embodiments described hereinbefore, the embodiments were described using, inter alia, TV1 and TV2 equipped with a display unit. However, the present invention can be carried out in the same way even with an STB, a recorder, etc. equipped with an external display unit.

### REFERENCE SIGNS LIST

1 Television receiver 1
2 Tuner/demodulator
3 Signal separator
4 Input unit
5 Control unit
5 Channel selection controller
7 Superimposition unit
8 Display unit
9 Communication I/F
10 Wireless router
11 External network
12 Wireless terminal
13 Communication I/F
14 Control unit
15 Input unit
17 Display unit
18 Base station
19 Television receiver 2
20 Memory
21 Signal separator
22 Tuner/demodulator
23 Storage
25 Storage
31 Mobile communication I/F
32 Memory
33 Acceleration sensor unit
34 Geomagnetic sensor unit
35 GPS receiver unit
36 Gyro sensor unit
39 Audio decoder
40 Video decoder
41 Speaker
42 Audio output unit
43 Video output unit
44 Digital I/F
50 Communication I/F
51 Control unit
52 Memory
53 Storage
99 Server
999 Broadcasting station

1. A remote operation system comprising a terminal device, a controlling device, and a controlled device,
wherein the terminal device includes:
a display unit that displays operation screen information;
an input unit that accepts an input for an operation to operate the controlled device, made based on the operation screen information; and
a first connection interface unit that receives operation screen information for displaying an operation screen on the display means from the controlling device and transmits operation information based on the operation accepted by the input means,
wherein the controlling device includes:
a unit for conversion to control information for converting the operation information received from the terminal device to control information for controlling the controlled device; and
a second connection interface unit that transmits the control information which has been output from the unit for conversion to control information to the controlled device and obtains status information on the controlled device.

2. The remote operation system according to claim 1,
wherein Electronic Program Guide (EPG) screen information for displaying a program guide on the display unit is included in the operation screen information,
channel selection operation information identifying a program included in the program guide is included in the operation information, and
channel selection information for causing the controlled device to display a program that is identified by the operation screen information in the control information.

3. The remote operation system according to claim 1,
wherein the controlling device is configured to be connected to the terminal device and the controlled device over an external network.

4. The remote operation system according to claim 3,
wherein the status information includes device information that can uniquely identify the controlled device, and
the unit for conversion to control information generates the control information according to the device information.

5. The remote operation system according to claim 3,
wherein the first connection interface unit includes a connection switching unit that preferentially switches to a connection to an external network depending on the situation of connecting to an external network or connecting to a communication network, and
an operation limiting unit is provided that limits operation using the terminal device when a connection is made to the communication network.

6. The remote operation system according to claim 3,
wherein the controlled device includes an interface processing unit having at least one or more Application Programming interfaces (APIs) for controlling the controlled device according to the control information,
the status information includes API information identifying an API that the interface processing unit has,
the controlling device includes a decision unit that decides whether or not to trigger API downloading based on the API information, and
the second connection interface unit transmits an API to the controlled device, if the decision unit has decided to trigger API downloading to the controlled device.

7. The remote operation system according to claim 6,
wherein the API information includes information as to whether or not an API has been installed in the controlled device or version information.

8. A terminal device for use in a remote operation system including a terminal device, a controlling device, and a controlled device, comprising:
a display unit that displays operation screen information;
an input unit that accepts an input for an operation to operate the controlled device, made based on the operation screen information; and
a connection interface unit that receives operation screen information for displaying an operation screen on the display means from the controlling device and transmits operation information based on the operation accepted by the input means.

9. The terminal device according to claim 8,
wherein Electronic Program Guide (EPG) screen information for displaying a program guide on the display unit is included in the operation screen information,
channel selection operation information identifying a program included in the program guide is included in the operation information, and
channel selection information for causing the controlled device to display a program that is identified by the operation screen information in the control information.

10. The terminal device according to claim 8,
wherein the connection interface unit includes a connection switching unit that preferentially switches to a connection to an external network depending on the situation of connecting to an external network or connecting to a communication network, and
an operation limiting unit is provided that limits operation using the terminal device when a connection is made to the communication network.
